(19) United States
(12) Patent Application Publication
(10) Pub. No.: US 2018/0109325 A1
(43) Pub. Date: Apr. 19, 2018

(54) OPTO-MECHANICAL SYSTEM AND METHOD HAVING CHAOS INDUCED STOCHASTIC RESONANCE AND OPTO-MECHANICALLY MEDIATED CHAOS TRANSFER

(71) Applicant: Washington University, St. Louis, MO (US)

(72) Inventors: Sahin Kaya Ozdemir, St. Louis, MO (US); Lan Yang, St. Louis, MO (US); Bo Peng, St. Louis, MO (US); Faraz Monifi, San Diego, CA (US)

(21) Appl. No.: 15/430,426

(22) Filed: Feb. 10, 2017

Related U.S. Application Data
(60) Provisional application No. 62/293,746, filed on Feb. 10, 2016.
(60) Provisional application No. 62/333,667, filed on May 9, 2016.

(51) Int. Cl. H04B 10/564; H01S 3/086; H01S 3/0941; H01S 3/105; H01S 3/00; H01S 3/10; H01S 3/107; H04J 14/02

(52) U.S. Cl. CPC H04B 10/564; H01S 3/086; H01S 3/0941; H01S 3/105; H04B 10/25; H01S 3/0014; H01S 3/10061; H01S 3/107; H04J 14/02; H01S 3/005

(57) ABSTRACT

An a system and method for chaos transfer between multiple detuned signals in a resonator mediated by chaotic mechanical oscillation induced stochastic resonance where at least one signal is strong and where at least one signal is weak and where the strong and weak signal follow the same route, from periodic oscillations to quasi-periodic and finally to chaotic oscillations, as the strong signal power is increased.

### CROSS REFERENCE

This application claims the benefit of and priority to provisional patent application Ser. No. 62/333,667, entitled Opto-Mechanical System And Method Having Chaos Induced Stochastic Resonance And Opto-Mechanically Mediated Chaos Transfer, filed May 9, 2016 and further claims the benefit of and priority to provisional patent application Ser. No. 62/293,746, entitled Chiral Photonics At Exceptional Points, filed Feb. 10, 2016, both of which are incorporated herein in their entirety.

### GOVERNMENT LICENSE RIGHTS

This invention was made with government support under W911NF-12-1-0026 awarded by the U.S. Army Research Office. The government has certain rights in the invention.

### BACKGROUND

### Field

This technology as disclosed herein relates generally to stochastic resonance and, more particularly, to chaos induced stochastic Resonance.

### Background

Chaotic dynamics has been observed in various physical systems and has affected almost every field of science. Chaos involves hypersensitivity to initial conditions of the system and introduces unpredictability to the system's output; thus, it is often unwanted. Chaos theory studies the behavior and condition of dynamical deterministic systems that are highly sensitive to initial conditions. Small differences in initial conditions (such as those due to rounding errors in numerical computation) yield widely diverging and random outcomes for such dynamical systems. This happens even though these systems are deterministic, meaning that their future behavior is fully determined by their initial conditions, with no random elements involved. In other words, the deterministic nature of these systems does not make them predictable. This behavior is known as deterministic chaos, or simply chaos.

Again, chaos is usually perceived as not being desirable. Therefore, using chaos, for example, to induce stochastic resonance in a physical system has not been significantly explored. Stochastic resonance is a phenomenon where a signal that is normally too weak to be detected by a sensor, can be boosted by adding white noise to the signal, which contains a wide spectrum of frequencies. The frequencies in the white noise corresponding to the original signal's frequencies will resonate with each other, amplifying the original signal while not amplifying the rest of the white noise (thereby increasing the signal-to-noise ratio which makes the original signal more prominent). Further, the added white noise can be enough to be detectable by the sensor, which can then be filtered out to effectively detect the original, previously undetectable signal. Stochastic resonance is observed when noise added to a system changes the system's behavior in some fashion. More technically, SR occurs if the signal-to-noise ratio of a nonlinear system or device increases for moderate values of noise intensity. It often occurs in bistable systems or in systems with a sensory threshold and when the input signal to the system is “sub-threshold”. For lower noise intensities, the signal does not cause the device to cross the threshold, so little signal is passed through it. For large noise intensities, the output is dominated by the noise, also leading to a low signal-to-noise ratio. For moderate intensities, the noise allows the signal to reach threshold, but the noise intensity is not so large as to swamp it. Stochastic resonance can be realized in chaotic systems, however, given the perceived undesirable nature of chaos, chaos induced stochastic resonance has not been significantly explored.

One type of physical system where chaotic oscillations can occur is that of opto-mechanical resonators. Micro- and nano-fabricated technologies, which have enabled the creation of novel structures in which enhanced light-matter interactions result in mechanical deformations and self-induced oscillations via the radiation pressure of photons are one type of opto-mechanical resonator. Suspended mirrors, whispering-gallery-mode (WGM) microresonators (e.g., microtoroids, microspheres, and microdisks), cavities with a membrane in the middle, photonic crystals zipper cavities are examples of such opto-mechanical systems where the coupling between optical and mechanical modes have been observed. These have opened new possibilities for fundamental and applied research. For example, they have been proposed for preparing non-classical states of light, high precision metrology, phonon lasing and cooling to their ground state. The nonlinear dynamics originating from the coupling between the optical and mechanical modes of an opto-mechanical resonator can cause both the optical and the mechanical modes to evolve from periodic to chaotic oscillations. However, again, chaos has been perceived to be undesirable in such systems.

Opto-mechanical chaos and the effect on an opto-mechanical system is a relatively unexplored area. Despite recent progress and interest in the involved nonlinear dynamics, optomechanical chaos remains largely unexplored experimentally. Further advancement is needed for the utilization and leveraging of chaos to induce stochastic resonance in optomechanical systems, which can advance the field and could be useful for high-precision measurements, for fundamental tests of nonlinear dynamics and other industrial applications.

*Further, in the past few years exciting progress has been made surrounding novel devices and functionalities enabled by new discoveries and applications of non-Hermitian physics in photonic systems. Exceptional points (EPs) are non-Hermitian degeneracies at which the eigenvalues and the corresponding eigenstates of a dissipative system coalesce when parameters are tuned appropriately. EPs universally occur in all open physical systems and dramatically affect their behavior, leading to counterintuitive phenomena such as loss-induced lasing, unidirectional invisibility, PTsymmetric lasers, just to name a few of the phenomena that have raised much attention recently. For example, a work on PT-symmetric microcavities and nonreciprocal light transport published in Nature Physics, 10, 394-398 (May 2014) has received broad media coverage and scientific interest, and has been cited several times by researchers coming from various fields, including optics, condensed matter, theoretical physics, and quantum mechanics.

### SUMMARY

The technology as disclosed herein includes a system and method for chaos transfer between multiple detuned signals in an optomechanical resonator where at least one signal is strong enough to induce optomechanical oscillations and where at least one signal is weak enough that it does not induce mechanical oscillation, optical nonlinearity or thermal effects and where the strong and weak signal follow the same route, from periodic oscillations to quasi-periodic and finally to chaotic oscillations, as the power of the strong signal is increased. The technology as disclosed and claimed uses optomechanically-induced Kerr-like nonlinearity and stochastic noise generated from mechanical backaction noise to create stochastic resonance. Stochastic noise is internally provided to the system by mechanical backaction.

With the present technology as disclosed and claimed herein, opto-mechanical systems demonstrate coupling between optical and mechanical modes. Chaos in the present technology has been leveraged a powerful tool to suppress decoherence, to achieve secure communication, and to replace background noise in stochastic resonance, which is a counterintuitive concept that a system's ability to transfer information can be coherently amplified by adding noise. The technology as disclosed and claimed herein demonstrates chaos-induced stochastic resonance in an opto-mechanical system, and the opto-mechanically-mediated chaos transfer between two optical fields such that they follow the same route to chaos. These results will contribute to the understanding of nonlinear phenomena and chaos in opto-mechanical systems, and may find application in chaotic transfer of information and for improving the detection of otherwise undetectable signals in opto-mechanical systems.

The nonlinear dynamics originating from the coupling between the optical and mechanical modes of an opto-mechanical resonator can cause both the optical and the mechanical modes to evolve from periodic to chaotic oscillations. These can find use in applications such as random number generation and secure communication as well as chaotic optical sensing. In addition, the intrinsic chaotic dynamics of a nonlinear system can replace the stochastic process (conventionally an externally-provided Gaussian noise) required for the stochastic resonance, which is a phenomenon in which the presence of noise optimizes the response of a nonlinear system leading to the detection of weak signals.

The technology as disclosed and claimed and the various implementations demonstrate opto-mechanically-mediated transfer of chaos from a strong optical field (pump) that excites mechanical oscillations, to a very weak optical field (probe) in the same resonator. The present technology demonstrates that the probe and the pump fields follow the same route, from periodic oscillations to quasi-periodic and finally to chaotic oscillations, as the pump power is increased. The chaos transfer from the pump to the probe is mediated by the mechanical motion of the resonator, because there is no direct talk between these two largely-detuned optical fields. Moreover, this is the first observation of stochastic resonance in an opto-mechanical system. The required stochastic process is provided by the intrinsic chaotic dynamics and the opto-mechanical backaction.

Periodic to chaotic oscillations can find use in applications such as random number generation and secure communication, as well as chaotic optical sensing. In addition, the intrinsic chaotic dynamics of a nonlinear system can replace the stochastic process (conventionally an externally-provided Gaussian noise) required for the stochastic resonance, which is a phenomenon in which the presence of noise optimizes the response of a nonlinear system leading to the detection of weak signals.

As discussed above, stochastic resonance is encountered in bistable systems, where noise induces transitions between two locally-stable states enhancing the system's response to a weak external signal. A related effect showing the constructive role of noise is coherence resonance, which is defined as stochastic resonance without an external signal. Both stochastic resonance and coherence resonance are known to occur in a wide range of physical and biological systems, including electronics, lasers, superconducting quantum interference devices, sensory neurons, nanomechanical oscillators and exciton-polaritons. However, to date they have not been reported in an opto-mechanical system. The technology as disclosed and claimed herein demonstrates chaos-mediated stochastic resonance in an opto-mechanical microresonator.

The technology as disclosed and claimed including the various implementations and applications demonstrate the ability to transfer chaos from a strong signal to a very weak signal via mechanical motion, such that the signals are correlated and follow the same route to chaos, which opens new venues for applications of opto-mechanics. One such direction would be to transfer chaos from a classical field to a quantum field to create chaotic quantum states of light for secure and reliable transmission of quantum signals. The chaotic transfer of classical and quantum information in such micro-cavity-opto-mechanical systems demonstrated here is limited by the achievable chaotic bandwidth, which is determined by the strength of the opto-mechanical interaction and the bandwidth restrictions imposed by the cavity. Qantum networks for long distance communication and distributed computing require nodes which are capable of storing and processing quantum information and connected to each other via photonic channels.

Recent achievements in quantum information have brought quantum networking much closer to realization. Quantum networks exhibit advantages when transmitting classical and quantum information with proper encoding into and decoding from quantum states. However, the efficient transfer of quantum information among many nodes has remained as a problem, which becomes more crucial for the limited-resource scenarios in large-scale networks. Multiple access, which allows simultaneous transmission of multiple quantum data streams in a shared channel, can provide a remedy to this problem. Popular multiple-access methods in classical communication networks include time-division multiple-access (TDMA), frequency division multiple-access (FDMA), and code-division multiple-access (CDMA).

In a CDMA network, the information-bearing fields a1 and a2, having the same frequency ω_{c}, are modulated by two different pseudo-noise signals, which not only broaden them in the frequency domain but also change the shape of their wavepackets. Thus, the energies of the fields a1 and a2 are distributed over a very broad frequency span, in which the contribution of ω_{c} is extremely small and impossible to extract without coherent sharpening of the ω_{c} components. This, on the other hand, is possible only via chaos synchronization which effectively eliminates the pseudo-noises in the fields and enables the recovery of a1 (a2) at the output a3 (a4) with almost no disturbance from a2 (a1). This is similar to the classical CDMA. Thus, this protocol can be referred to as q-CDMA.

The nonlinear coupling between the optical fields and the Duffing oscillators and the chaos synchronization to achieve the chaotic encoding and decoding could be realized using different physical platforms. For example, in opto-mechanical systems, the interaction Hamiltonian can be realized by coupling the optical field via the radiation pressure to a moving mirror connected to a nonlinear spring. Chaotic mechanical resonators can provide a frequency-spreading of several hundreds of MHz for a quantum signal, and this is broad enough, compared to the final recovered quantum signal, to realize the q-CDMA and noise suppression. Chaos synchronization with a mediating optical field, similar to that used to synchronize chaotic semiconductor lasers for high speed secure communication, would be the method of choice for long-distance quantum communication. The main difficulty in this method, however, will be the coupling between the classical chaotic light and the information-bearing quantum light. The present technology provides a solution to this coupling challenge.

One can increase the chaotic bandwidth by using waveguide structures which have larger bandwidths than cavities. Moreover, the presence of chaos-mediated stochastic resonance in opto-mechanical systems illustrates not only the nonlinear dynamics induced by the opto-mechanical coupling, but also illustrates the use stochastic resonance to enhance the signal-processing capabilities to detect and manipulate weak signals. The technology as disclosed and claimed herein can be extended to micro/nano-mechanical systems where frequency-separated mechanical modes are coupled to each other, e.g., acoustic modes of a micromechanical resonator or cantilevers regularly spaced along a central clamped-clamped beam. Generating, transferring and controlling opto-mechanical chaos and using it for stochastic resonance makes it possible to develop electronic and photonic devices that exploit the intrinsic sensitivity of chaos.

This work has two aspects: First, optomechanical oscillations induce chaos on a pump strong field. Then the detuned probe is affected and it also follows the same route to chaos. One can say optomechanically-induced chaos transfer between optical fields and modes. Second, is the stochastic resonance, independent of First. Here Pump induces mechanical oscillations, which then induce chaotic behavior and the stochastic noise via backaction. Then a probe feels a nonlinear system with stochastic noice, and as a result it is signal-to-noise ratio first increases with increasing pump power and then decreases.

Further, one technology disclosed herein is a micro resonator operating close to an EP where a strong chirality can be imposed on an otherwise non-chiral system, and the emission direction of a waveguide-coupled micro laser can be tuned from bidirectional to a fully unidirectional output in a preferred direction. By directly establishing the essential link between the non-Hermitian scattering properties of a waveguide-coupled whispering-gallery-mode (WGM) micro resonator and a strong asymmetric backscattering in the vicinity of an EP, allows for dynamic control of the chirality of resonator modes, which is equivalent to a switchable direction of light rotation inside the resonator. This enables the ability to tune the direction of a WGM micro laser from a bidirectional emission to a unidirectional emission in the preferred direction: When the system is away from the EPs, the resonator modes are non-chiral and hence laser emission is bidirectional, whereas in the vicinity of EPs the modes become chiral and allow unidirectional emission such that by transiting from one EP to another EP the direction of unidirectional emission is completely reversed. Such an effect has not been observed or demonstrated before.

Moreover, the ability to controllably tune the ratio of the light fields propagating in opposite directions on demand is achieved—the maximum impact is reached right at the EP, where modes are fully chiral. To achieve this highly non-trivial feature, the system leverages the use of the fact that the out-coupling of light via scatterers placed outside the resonator leads to an effective breaking of time-reversal symmetry in its interior. Such a system opens a new avenue to explore chiral photonics on a chip at the crossroads between practical applications and fundamental research. WGM resonators play a special role in modern photonics, as they are ideal tools to store and manipulate light for a variety of applications, ranging from cavity-QED and optomechanics to ultra-low threshold lasers, frequency combs and sensors. Much effort has therefore been invested into providing these devices with new functionalities, each of which was greeted with enormous excitement. Take here as examples the first demonstrations to detect ultra-small particles; to observe the PT-symmetry phase transition with an associated breaking of reciprocity; to observe the loss-induced suppression and revival of lasing at exceptional points; or the measurement based control of a mechanical oscillator. By explicitly connecting the features of resonator modes with the intriguing physics of EP, the system adds a new and very convenient functionality, which is a benefit all the fields where these devices are in use.

Controlling the emission and the flow of light in micro and nanostructures is crucial for on chip information processing. The system as disclosed imposes a strong chirality and a switchable direction of light propagation in an optical system by steering it to an exceptional point (EP)—a degeneracy universally occurring in all open physical systems when two eigenvalues and the corresponding eigenstates coalesce. In one implementation a fiber-coupled whispering-gallery-mode (WGM) resonator, dynamically controls the chirality of resonator modes and the emission direction of a WGM microlaser in the vicinity of an EP: Away from the EPs, the resonator modes are non-chiral and laser emission is bidirectional. As the system approaches an EP the modes become chiral and allow unidirectional emission such that by transiting from one EP to another one the direction of emission can be completely reversed. The system operation results exemplify a very counterintuitive feature of non-Hermitian physics that paves the way to chiral photonics on a chip.

The features, functions, and advantages that have been discussed can be achieved independently in various implementations or may be combined in yet other implementations further details of which can be seen with reference to the following description and drawings. These and other advantageous features of the present technology as disclosed will be in part apparent and in part pointed out herein below.

### BRIEF DESCRIPTION OF THE DRAWINGS

For a better understanding of the present technology as disclosed, reference may be made to the accompanying drawings in which:

FIG. 1a is a view of the microtoroid illustrating the mechanical motion induced by optical radiation force;

FIG. 1b is a typical transmission spectra obtained by scanning the wavelength of a tunable laser with a power well-below (red) and above (blue) the mechanical oscillation threshold;

FIG. 1c is A typical electrical spectrum analyzer (ESA) trace of the detected photocurrent below the mechanical oscillation threshold;

FIG. 2A through 2C are phase diagrams of the pump fields in periodic (left), quasi periodic (middle), and chaotic (right) regimes;

FIG. 2D through 2F is phase diagrams of the probe fields in periodic (left), quasi periodic (middle), and chaotic (right) regimes;

FIG. 2G is a Bifurcation diagram of the pump fields;

FIG. 2H is a Bifurcation diagram of the probe fields;

FIG. 3a is Maximal Lyapunov exponents for the pump (blue) and the probe (red) fields as a function of the pump power;

FIG. 3b is an illustration of the spectral response of a Bandwidth broadening of the probe as a function of the pump power;

FIG. 3c is a typical spectra obtained for the probe at different pump powers;

FIG. 3d is a typical spectra obtained for the probe at different pump powers;

FIG. 3e is a typical spectra obtained for the probe at different pump powers;

FIG. 4a is Signal-to-noise ratio (SNR) of the probe as a function of the pump power;

FIG. 4b is An illustration conceptualizing chaos-mediated stochastic resonance in an opto-mechanical resonator;

FIG. 4c is an illustration of increasing the pump power first increases the SNR to its maximum and then reduces it—Mean <τ>;

FIG. 4d is an illustration of increasing the pump power first increases the SNR to its maximum and then reduces it, scaled standard deviation R of interspike intervals τ;

FIG. 5 is a schematic diagram illustration a configuration of the technology under test;

FIG. 6a is demonstration of power spectra for the pump and probe fields at various pump powers corresponding to periodic;

FIG. 6b is a demonstration of power spectra for the pump and probe fields at various pump powers corresponding to quasi-periodic;

FIG. 6c is a demonstration of power spectra for the pump and probe fields at various pump powers corresponding to chaotic regime;

FIG. 6d is a demonstration of power spectra for the pump and probe fields at various pump powers corresponding to periodic;

FIG. 6e is a demonstration of power spectra for the pump and probe fields at various pump powers corresponding to quasi-periodic;

FIG. 6f is a demonstration of power spectra for the pump and probe fields at various pump powers corresponding to chaotic regime;

FIG. 7a through 7f are a demonstration of opto-mechanically-induced period-doubling in the pump and probe fields;

FIG. 7g through 7l are a numerical simulation of opto-mechanically-induced period-doubling in the pump and probe fields;

FIG. 7m is an illustration of a mechanical transverse mode in a micro-toroid;

FIG. 7n is an illustration of a mechanical longitudinal mode in a micro-toroid;

FIG. 8a is an illustration of periodic mechanical motion of the microtoroid resonator when the pump and probe fields are both in the chaotic regime;

FIG. 8b is an illustration of periodic mechanical motion of the microtoroid resonator when Filtering by the mechanical resonator: the mechanical resonator works as a low-pass filter;

FIG. 9a illustrates the Maximum of the Lyapunov exponent for the pump (red spectra) and probe (blue spectra) fields showing effect of the pump-cavity detuning;

FIG. 9b is illustrates the Maximum of the Lyapunov exponent for the pump (red spectra) and probe (blue spectra) fields showing effect of the probe-cavity detuning on the maximum Lyapunov exponents of the pump and probe fields;

FIG. 9c is an illustration of Maximum of the Lyapunov exponent for the pump (red spectra) and probe (blue spectra) fields showing the effect of the damping rate of the pump;

FIG. 9d is an illustration of Maximum of the Lyapunov exponent for the pump (red spectra) and probe (blue spectra) fields showing the effect of damping rate of the probe on the maximum Lyapunov exponents of the pump and probe fields;

FIG. 10 is an illustration of a signal-to-noise ratio (SNR) for the pump and probe signals.

FIGS. 11a through 11c are an output spectra shos that the spectral location of the resonance peak do not change with increasing pump power;

FIGS. 11d through 11f are an output spectra obtained in the numerical simulations of stochastic resonance show that the spectral location of the resonance peak stays the same for increasing pump power;

FIGS. 11g through 11i are an output spectra obtained in the numerical simulations of coherence resonance which show that the spectral location of the resonance peaks change with increasing pump power;

FIGS. 12a through 12b is a mean interspike interval and its variation calculated from the output signal in the probe mode;

FIGS. 12c through 12d is a mean interspike interval and its variation obtained in the numerical simulation of stochastic resonance with input weak probe; and

FIGS. 12e through 12f is a mean interspike interval and its variation obtained in the numerical simulation of coherence resonance in our system without input weak probe.

FIGS. 13a-13c illustrate the experimental configuration used in the technology and the effect of scatterers.

FIGS. 14a-14h illustrate the experimental observation of scatterer-induced asymmetric backscattering.

FIGS. 15a and 15B illustrate Controlling directionality and intrinsic chirality of whispering-gallery-modes.

FIGS. 16a-16e illustrate Scatterer-induced mirror-symmetry breaking at an EP.

FIG. 17 illustrate Schematic of the setup with the definitions of the parameters and signal propagation directions.

FIGS. 18a and 18b illustrate the eigenmode evolution of the non-Hermitian system as a function of the effective size factor d and the relative phase angle β between the scatterers

FIGS. 19a and 19b illustrate experimentally obtained mode spectra as the relative phase angle β between the scatterers was varied

FIGS. 20a and 20b illustrate experimentally obtained evolution of eigenfrequencies as the relative size of the scatterers was varied at different relative phase angles β

FIG. 21 illustrate experimentally obtained evolution of the splitting quality factor as a function of β for fixed relative size factor

FIGS. 22a-22d illustrate weights of CW and CCW components in the eigenmodes as the relative phase difference β between the two nanoscatterers is varied

FIGS. 23a and 23b compare the chirality as determined from the eigenvalue calculations for the lasing cavity with the chirality as determined from the transmission calculations.

FIG. 24 Comparison of the chirality definitions for α_{TMA}, α_{lasing} and αₜᵣₐₙₛₘᵢₛₛᵢₒₙ

FIGS. 25a-25d Asymmetric backscattering intensities |B_{CW/CCW}|² from a CW to a CCW wave [left panel: (A) and (C)] and from a CCW to a CW mode [right panel: (B) and (D)].

FIGS. 26a-26f Directionality with a biased input (CW) as a function of the relative phase difference between two scatterers (A).

While the technology as disclosed is susceptible to various modifications and alternative forms, specific implementations thereof are shown by way of example in the drawings and will herein be described in detail. It should be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DESCRIPTION

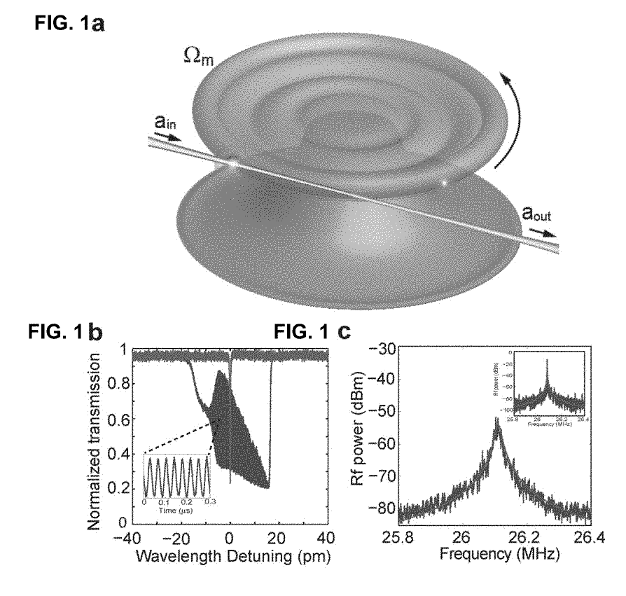

According to the implementation(s) of the present technology as disclosed, various views are illustrated in FIG. 1-12 and like reference numerals are being used consistently throughout to refer to like and corresponding parts of the technology for all of the various views and figures of the drawing. Also, please note that the first digit(s) of the reference number for a given item or part of the technology should correspond to the Fig. number in which the item or part is first identified.

One implementation of the present technology as disclosed comprising an opto-mechanical system having opto-mechanically induced chaos and stochastic resonance teaches a novel system and method for opto-mechanically mediated chaos transfer between two optical fields such that they follow the same route to chaos. The opto-mechanical system can be utilized for encoding chaos on a weak signal for chaotic encoding that can be used in secure communication. Chaos induced stochastic resonance in opto-mechanical systems are also applicable for use in improving signal detection.

The technology as disclosed and claimed demonstrates generating and transferring optical chaos in an opto-mechanical resonator. The technology demonstrates opto-mechanically-mediated transfer of chaos from a strong optical field (pump) that excites mechanical oscillations, to a very weak optical field (probe) in the same resonator. The technology demonstrates that the probe and the pump fields follow the same route, from periodic oscillations to quasi-periodic and finally to chaotic oscillations, as the pump power is increased. The chaos transfer from the pump to the probe is mediated by the mechanical motion of the resonator, because there is no direct talk between these two largely-detuned optical fields. Moreover, the technology demonstrates stochastic resonance in an opto-mechanical system. The required stochastic process is provided by the chaotic dynamics and the opto-mechanical backaction.

The details of the technology as disclosed and various implementations can be better understood by referring to the figures of the drawing. Referring to FIGS. 1a through 1c, a basic configuration of the technology was tested, which included a fiber-taper-coupled WGM microtoroid resonator (FIG. 1a.). FIG. 1a is an illustration of a whispering-gallery mode microtoroid opto-mechanical microresonator illustrating the mechanical motion induced by optical radiation force. FIG. 1b illustrates a typical transmission spectra obtained by scanning the wavelength of a tunable laser with a power well below and above the mechanical oscillation threshold. At high powers, thermally induced linewidth broadening and the fluctuation due to the mechanical oscillations kick in. A close up view of the fluctuations in the transmission, obtained at a specific wavelength of the laser, reveals a sinusoidal oscillaton at a frequency Ωₘ of the mechanical oscillation.

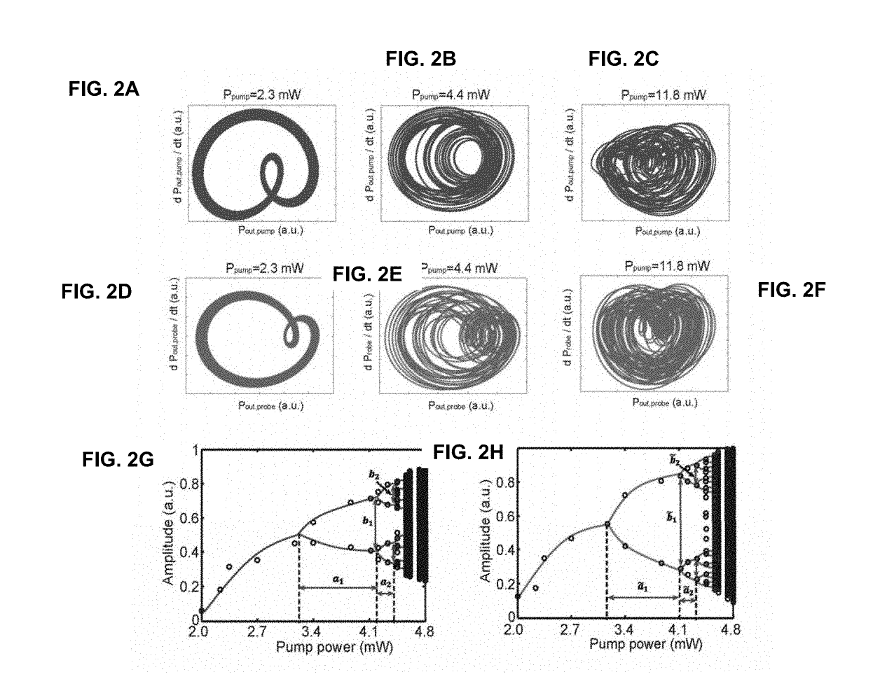

FIG. 1c illustrates a typical electrical system analyzer (ESA) trace of the detected photocurrent below the mechanical oscillation threshold. The inset shows the spectrum above the threshold. The traces represent the demonstrated data, and the curves are the best fitting. Referring to FIGS. 2A through H, Opto-mechanically-mediated chaos generation and transfer between optical fields A-C and D-F. Phase diagrams of the pump Figs (A-C) and the probe Figs (D-F) fields in periodic (left), quasi periodic (middle), and chaotic (right) regimes. The phase diagrams were obtained by plotting the first time derivative of the measured output power of the pump Figs (A-C) and the probe Figs (D-F) fields as a function of the respective output powers. Figs G, H, Bifurcation diagrams of the pump Fig (G) and the probe Fig (H) fields as function of the input pump power. The pump and probe enter the chaotic regime via the same bifurcation route. The ratios of the bifurcation intervals for the pump a₁/a₂ and probe ã₁/ã₂ are both 4.5556. The ratio between the width of a tine and the width of one of its two subtines is b₁/b₂=2.6412 for the pump and \tilde{b}₁/\tilde{b}₂=2.8687 for the probe.

When the power of the pump field is increased, it is observed that the transmitted pump light transited from a fixed state to a region of periodic oscillations, and finally to the chaotic regime through period-doubling bifurcation cascades (see FIGS. 2A-2C). The periodic regime, with only a few sharp peaks, and the quasi-periodic regime, with infinite discrete sharp peaks, in the output spectrum of the pump field. Finally, the whole baseline of the output spectrum of the pump field increased, implying that the system entered the chaotic regime. All these results coincide very well with previous studies.

These phenomena observed for the pump field originate from the nonlinear opto-mechanical coupling between the optical pump field and the mechanical mode of the resonator. Intuitively, one may attribute this observed dynamic to the chaotic mechanical motion of the resonator. However, the reconstructed mechanical motion of the resonator, using the experimental data in the theoretical model, showed that the optical signal was chaotic even if the mechanical motion of the resonator was periodic. Thus, it can be concluded that the reason for the chaotic behaviour in the optical field in our experiments is the strong nonlinear optical Kerr response induced by the nonlinear coupling between the optical and mechanical modes.

Simultaneously monitoring the probe field reveals that as the pump power is increased, the probe, also, experienced periodic, quasi periodic, and finally chaotic regimes. More importantly, the pump and probe entered the chaotic regime via the same bifurcation route (FIG. 2), that is both optical fields experienced the same number of period-doubling cascades, and the doubling points occurred at the same values of the pump power. These features are clearly seen in the phase-space plots (FIG. 2A-2C and 2D-2F) and in the bifurcation diagrams (FIG. 2G and 2H). The demonstrated data fits very well with bifurcation, in which each periodic region is smaller than the previous region by the factor a₁/a₂=4.5556 for the pump and ã₁/ã₂=4.5556 for the probe, and these factors are close to the first universal Feigenbaum constant 4.6692. The ratio between the width of a tine and the width of one of its two sub-tines for the pump is b₁/b₂=2.6412, and that for the probe \tilde{b}₁/\tilde{b}₂=2.8687, which are both close to the second universal Feigenbaum constant 2.5029 (two mathematical constants, which both express ratios in a bifurcated non-linear system).

In order to effectively demonstrate the present technology, the probe field is sufficiently weak such that it could not induce any mechanical oscillations of its own, and the large frequency-detuning between the pump field (in the 1550 nm band) and the probe field (in the 980 nm band) assured that there was no direct crosstalk between the optical fields. Thus the observed close relation between the route-to-chaos for the pump and probe fields can only be attributed to the fact that the periodic mechanical motion of the microresonator mediates the coupling between the optical modes via opto-mechanically-induced Kerr-like nonlinearity (the induced refractive index change is directly proportional to the square of the field instead of varying in linearity with it), and enables the probe to follow the pump field.

To demonstrate the technology, light from an external cavity laser in the 1550 nm band is first amplified by an erbium-doped fiber amplifier (EDFA) and then coupled into a microtoroid to act as the pump for the excitation of the mechanical modes. Optical transmission spectrum, is obtained by scanning the wavelength of the pump laser, which shows a typical Lorentzian lineshape (follows a fourier transform line broadening function) for low powers of the pump field (FIG. 1b). The quality factor of this optical mode was 10⁷. As the pump power is increased, the spectrum changed from a Lorentzian lineshape to a distorted asymmetric lineshape due to thermal nonlinearity. This helps to keep the pump laser detuned with respect to the resonant line of the microcavity. As a result, radiation-pressure-induced mechanical oscillations take place as reflected by the oscillations imprinted on the optical transmission spectra (FIG. 1b). This then leads to the modulation of the transmitted light at the frequency of the mechanical motion (FIG. 1b, inset). The Rf power versus frequency traces, obtained using an electrical spectrum analyzer (ESA), reveals a Lorentzian spectrum located at Ωₘ≈26.1 MHz with a linewidth of ˜200 KHz, implying a mechanical quality factor of Qₘ≈131, when the pump power is below the threshold of mechanical oscillation (FIG. 1c). For powers above the threshold, the linewidth narrowing is clearly observed (FIG. 1c, inset)

In order to demonstrate the effect of the mechanical motion induced by the strong pump field on a weak light field (probe light) within the same resonator, an external cavity laser with emission in the 980 nm band can be used. The power of the probe laser is chosen such that it does not induce any thermal or mechanical effect on the resonator, i.e., its power is well below the threshold of mechanical oscillations. The transmission spectra of the pump and the probe fields are separately monitored by photodiodes connected to an oscilloscope and an ESA. The probe resonance mode had a quality factor of 6×10⁶.

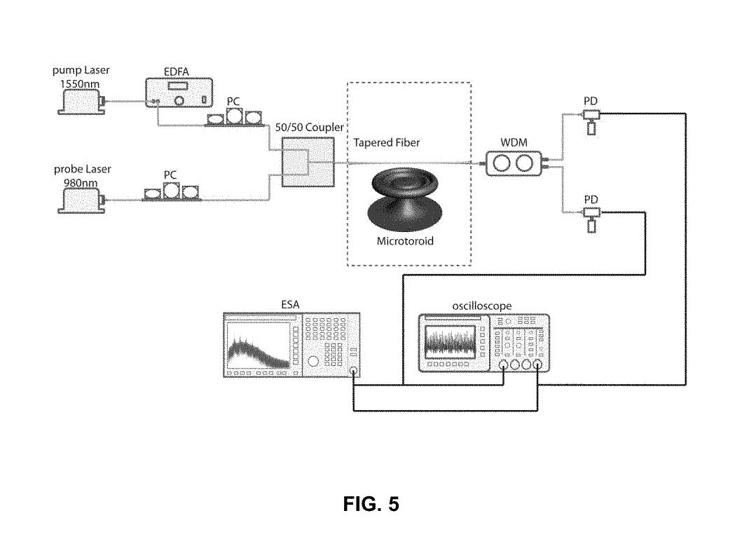

Referring to FIG. 5, a more detailed schematic diagram is provided of one implementation of the technology being demonstrated, which includes a pump and probe configuration. The pump (1550 nm band) and the probe (980 nm band) fields are coupled into and out of a microtoroid resonator via the same tapered fiber in the same direction. An Erbium-doped fibre amplifier EDFA is utilized for signal amplification. A PC is and a Polarization controller are utilized for control. A wavelength division multiplexer (WDM), a Photodetector for signal detection, and an Electrical spectrum analyzer (ESA) are utilized.

An optical pump field, provided by a tunable External Cavity Laser Diode (ECLD) in the 1550 nm band, is first amplified using an erbium-doped fiber amplifier (EDFA), and then coupled into a fiber, using a 2-to-1 fiber coupler, together with a probe field provided by a tunable ECLD in the 980 nm band. A section of the fiber is tapered, to enable efficient coupling of the pump and probe fields into and out of a microtoroid resonator. The pump and probe fields in the transmitted signals are separated from each other using a wavelength division multiplexer (WDM) and then sent to two separate photodetectors (PDs). The electrical signals from the PDs are then fed to an oscilloscope, in order to monitor the time-domain behavior, and also to an electrical spectrum analyzer (ESA) to obtain the power spectra.

It can be concluded that the intracavity pump and probe fields do not directly couple to each other, and that the probe and pump fields couple to the same mechanical mode of the microcavity with different coupling strengths. The technology demonstrates that in such a situation, the mechanical mode mediates an indirect coupling between the fields. The dynamical equation for the intracavity pump mode coupled to the mechanical mode of the cavity can be written as

\dot{a}ₚᵤₘₚ−[γₚᵤₘₚ−i(Δₚᵤₘₚ−gₚᵤₘₚX)]aₚᵤₘₚ+iκϵₚᵤₘₚ(t), (S1)

where aₚᵤₘₚ is the complex amplitude of the intracavity pump field, γₚᵤₘₚ is the damping rate of the cavity pump mode, ϵₚᵤₘₚ(t) represents the amplitude of the input pump field, κ is the pump-resonator coupling rate, Δₚᵤₘₚ is the frequency detuning between the input pump field and the cavity resonance, X is the position of the mechanical mode coupled to aₚᵤₘₚ, and gₚᵤₘₚ is the strength of the optomechanical coupling between the optical pump field and the mechanical mode. This equation can be solved in the frequency-domain by using the Fourier transform as

$${a}_{pump} ( ω ) = \frac{- {ig}_{pump}}{i ( ω - {Δ}_{pump} ) + {γ}_{pump}} {\int }_{- ∞}^{+ ∞} X ( ω - {ω}_{1} ) {a}_{pump} ( {ω}_{1} ) d {ω}_{1} + \frac{i {κɛ}_{pump} ( ω )}{i ( ω - {Δ}_{pump} ) + {γ}_{pump}} , \qquad ( S2 )$$

where aₚᵤₘₚ(ω) X(ω), and ϵₚᵤₘₚ(ω) are the Fourier transforms of the time-domain signals aₚᵤₘₚ(t), X(t), and ϵₚᵤₘₚ(t). Since the dynamics of the mechanical motion X(t) is slow compared to that of the optical mode, the convolution term can be replaced in the above equation by the product aₚᵤₘₚ (ω)X(ω), under the slowly-varying envelope approximation, which then leads to

$$[ 1 - \frac{- {ig}_{pump}}{i ( ω - {Δ}_{pump} ) + {γ}_{pump}} X ( ω ) ] {a}_{pump} ( ω ) = \frac{- i {κɛ}_{pump} ( ω )}{i ( ω - {Δ}_{pump} ) + {γ}_{pump}} . \qquad ( S3 )$$

X(ω) is in general so small that we have gₚᵤₘₚ²|X(ω)|²«(ω−Δₚᵤₘₚ)²+γₚᵤₘₚ². Then using the identity 1/(1−x)≈1+x, for x«1, we can re-write Eq. (S3) as

$${a}_{pump} ( ω ) = [ 1 + \frac{- {ig}_{pump}}{i ( ω - {Δ}_{pump} ) + {γ}_{pump}} X ( ω ) ] \frac{- i {κɛ}_{pump} ( ω )}{i ( ω - {Δ}_{pump} ) + {γ}_{pump}} . \qquad ( S4 )$$

By multiplying the above equation with its conjugate and dropping the linear term of X(ω), which is zero on average, we can obtain the relation between the spectrum Sₚᵤₘₚ(ω)=|aₚᵤₘₚ(ω)|² of the optical mode aₚᵤₘₚ and the spectrum of the mechanical motion S_{X}(ω)=|X(ω)|² as

$$\begin{matrix}{S}_{pump} ( ω ) = \frac{{κ}^{2} {ɛ}_{pump}^{2}}{{γ}_{pump}^{2}} {χ}_{pump} ( ω ) [ 1 + \frac{{g}_{pump}^{2}}{{γ}_{pump}^{2}} {χ}_{pump} ( ω ) {S}_{X} ( ω ) ] , & ( S5 ) \\ Where & \\ {χ}_{pump} ( ω ) = \frac{{γ}_{pump}^{2}}{{γ}_{pump}^{2} + {( ω - {Δ}_{pump} )}^{2}} & ( S6 )\end{matrix}$$

is a susceptibility coefficient. By further introducing the normalized spectrum

$${\tilde{S}}_{pump} ( ω ) = {S}_{pump} ( ω ) - \frac{{κ}^{2} {ɛ}_{pump}^{2}}{{γ}_{pump}^{2}} {χ}_{pump} ( ω ) , \qquad ( S7 )$$

the above equation can be written as

$${\tilde{S}}_{pump} ( ω ) = \frac{{κ}^{2} {ɛ}_{pump}^{2} {g}_{pump}^{2}}{{γ}_{pump}^{4}} {χ}_{pump}^{2} ( ω ) {S}_{X} ( ω ) , \qquad ( S8 )$$

A similar equation can be obtained by analyzing the spectrum of the optical mode a_{probe} coupled to the probe field as

$$\begin{matrix}{\tilde{S}}_{probe} ( ω ) = \frac{{κ}^{2} {ɛ}_{probe}^{2} {g}_{probe}^{2}}{{γ}_{probe}^{4}} {χ}_{probe}^{2} ( ω ) {S}_{X} ( ω ) , & ( S9 ) \\ Where & \\ {χ}_{probe} ( ω ) = \frac{{γ}_{probe}^{2}}{{γ}_{probe}^{2} + {( ω - {Δ}_{probe} )}^{2}} , & ( S10 )\end{matrix}$$

γ_{probe} is the damping rate of the cavity mode coupled to the probe field, ϵ_{probe}(t) represents the amplitude of the input probe field, Δ_{probe} is the detuning between the input probe field and the cavity resonance, and g_{probe} is the coupling strength between the optical mode a_{probe} and the mechanical mode.

From Eqs. (S8) and (S9), the relation between the normalized spectra \tilde{S}ₚᵤₘₚ(ω) and \tilde{S}_{probe} (ω) is obtain as

$$\begin{matrix}{\tilde{S}}_{probe} ( ω ) = G \frac{{χ}_{probe}^{2} ( ω )}{{χ}_{pump}^{2} ( ω )} {\tilde{S}}_{pump} ( ω ) , & ( S11 ) \\ Where & \\ G = \frac{{ɛ}_{probe}^{2} {g}_{probe}^{2} {γ}_{pump}^{4}}{{ɛ}_{pump}^{2} {g}_{pump}^{2} {γ}_{probe}^{4}} . & ( S12 )\end{matrix}$$

If we assume that the detunings and damping rates of the optical modes are close to each other, i.e., Δₚᵤₘₚ≈Δ_{probe} and γₚᵤₘₚ≈γ_{probe}, we have χ_{probe}²(ω)/χₚᵤₘₚ²(ω)≈1, leading to

\tilde{S}_{probe}(ω)≈G \tilde{S}ₚᵤₘₚ(ω). S(13)

This implies that the spectra of the pump and probe fields are correlated with each other. The correlation factor G is mainly determined by the opto-mechanical coupling strengths of the pump and the probe fields as well as the intensities of these fields.

The relation between the spectra of the pump and probe signals shows that the opto-mechanical coupling strengths gₚᵤₘₚ and g_{probe} of the pump and probe field to the excited mechanical mode determine how closely the probe field will follow the pump field. Clearly, these coupling strengths do not change the shape of the spectrum, and this is the reason why the probe signal follows the pump signal in the frequency domain and enters the chaotic regime via the same bifurcation route, despite the fact that they are far detuned from each other (FIG. 2G, 2H).

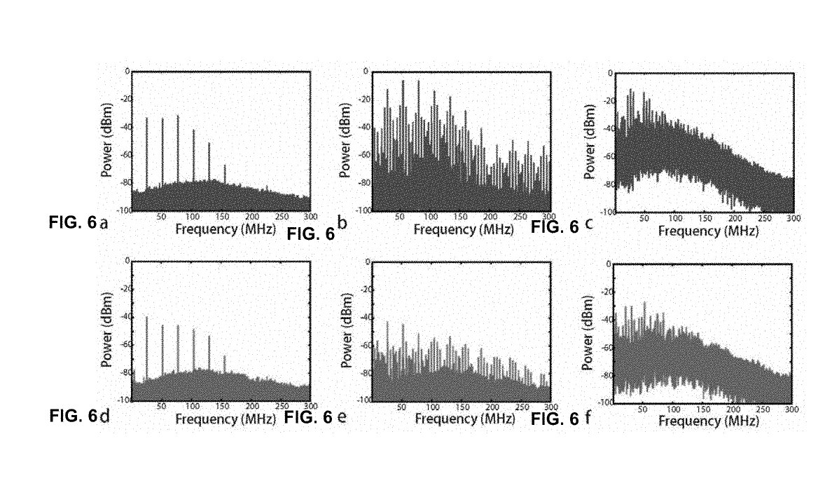

When demonstrating the technology, the mechanical motion is excited by the strong pump field, and the probe is chosen to have such a low power that it could not induce any mechanical oscillations. The large pump and probe detuning ensured that there is no direct coupling between them. The fact that both the pump and the probe are within the same resonator that sustains the mechanical oscillation naturally implies that both the pump and the probe are affected by the same mechanical oscillation with varying strengths, depending on how strongly they are coupled to the mechanical mode. The pump and probe spectra (FIG. 6) obtained by experimentation under these conditions agree well with the prediction given in Eq. (S13), in the sense that the spectra of the pump and the probe fields become correlated if they couple to the same mechanical mode. The slight differences in phase diagrams obtained in the demonstration (FIG. 2A-2C, 2D-2F) imply that different coupling strengths of the pump and probe to the same mechanical mode, due to the difference in their spatial overlaps with the mechanical mode, affect the trajectories and thus the phase diagrams.

One implementation of the technology as disclosed and claimed is configured to control chaos and stochastic noise. The technology is configured to control chaos and stochastic noise by increasing the pump power (1550 nm band) on the detected pump and the probe signals (980 nm band), on the degree of sensitivity to initial conditions and chaos in the probe. This is accomplished by calculating the maximal Lyapunov exponent (MLE) from the detected pump and probe signals. Lyapunov exponents quantify the sensitivity of a system to initial conditions and give a measure of predictability. They are a measure of the rate of convergence or divergence of nearby trajectories in phase space.

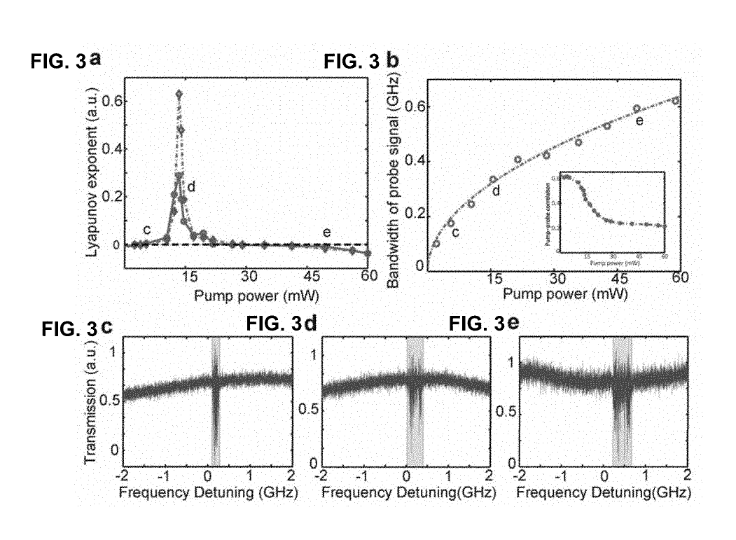

The behavior of the MLE is a good indicator of the degree of convergence or divergence of the whole system. A positive MLE implies divergence and sensitivity to initial conditions, and that the orbits are on a chaotic attractor. If, on the other hand, the MLE is negative, then trajectories converge to a common fixed point. A zero exponent implies that the orbits maintain their relative positions and they are on a stable attractor. The technology demonstrates that with increasing pump power the degree of chaos and sensitivity to initial conditions, as indicated by the positive MLE, first increase and then decreased after reaching its maximum, both for the pump and the probe fields (FIG. 3a). With further increase of the pump, the MLE becomes negative, indicating a reverse period-doubling route out of chaos into periodic dynamics. In addition to the pump power, the pump-cavity detuning and the damping rate of the pump affect the MLE for both the pump and the probe fields.

Referring to FIGS. 3b through 3e, Maximal Lyapunov exponents for the pump (blue) and the probe fields as a function of the pump power is illustrated. The Lyapunov exponents describe the sensitivity of the transmitted pump and the probe signals to the input pump power. Circles and diamonds are the exponents calculated from measured data. The blue and red curves are drawn as eye guidelines. FIG. 3b illustrate bandwidth broadening of the probe as a function of the pump power. Circles is the demonstrated data and the red curve is the fitting curve. The inset shows the cross-correlation between the pump and probe fields as a function of the pump powerTypical spectra obtained for the probe at different pump powers. Power increases from c to e, clearly showing the bandwidth broadening. The corresponding Lyapunov exponents and bandwidths are labelled in a and b.

The bandwidth D of the probe signal increases with increasing pump power (FIG. 3b-e), and the relation between the bandwidth D of the probe signal and the pump power Pₚᵤₘₚ follows the power function D=αPₚᵤₘₚ^{1/2}, with α=1.65×10⁸ Hz/mW^{1/2} (FIG. 3b). This is contrary to the expectation that the less (more) chaotic the signal is, the smaller (larger) its bandwidth is. This can be attributed to the presence of both the deterministic noise from chaos and the stochastic noise from the opto-mechanical backaction. According to Newton's third law, for every action there is always an equal and opposite reaction. With similar inevitability, this time in quantum physics, for every measurement there is always a perturbation of the object being measured. This phenomenon, known as quantum back-action, could now be put to practical use because it can alter the frequency, position, and damping rate of a resonator. For example in an opto-mechanical system, radiation pressure caused by circulating photons create optomechanical oscillations and opto-mechanical dynamics, o[tpmechanical oscillations then back-action on the light (photons) and change their charateristics, inducing noise, shifting their frequency. The system is chaotic for the range of pump power where the maximal Lyapunov exponent is positive (FIG. 3a). For smaller or larger power levels, the system is not in the chaotic regime. Thus, chaos-induced noise is present only for a certain range of pump power.

The effect of opto-mechanical backaction, on the other hand, is always present in the power range shown in FIG. 3, and its effect increases with increasing pump power, where the higher the pump power, the larger the stochastic noise due to backaction (FIG. 3e has more backaction noise than FIG. 3d, which, in turn, has more than FIG. 3c).

In FIG. 3c and FIG. 3e (corresponding to zero or negative maximum Lyapunov exponent), the bandwidth is almost completely determined by the opto-mechanical backaction, with very small or no contribution from chaos. In FIG. 3d, the system is in the chaotic regime, and thus both chaos and the backaction contribute to noise, leading to a larger probe bandwidth in FIG. 3d than in FIG. 3c. At the pump power of FIG. 3e, on the other hand, the system is no more in chaotic. However, backaction noise reaches such high levels that it surpasses the combined effect of chaos and backaction noises of FIG. 3d. As a result, FIG. 3e has a larger bandwidth. Thus, for the present technology, the pump and the probe became less chaotic when the pump power was increased beyond a critical value; however, at the same time their bandwidths increased, implying more noise contribution from the optomechanical backaction. Therefore, the correlation between the pump and probe fields decreased with increasing pump power (FIG. 3b inset).

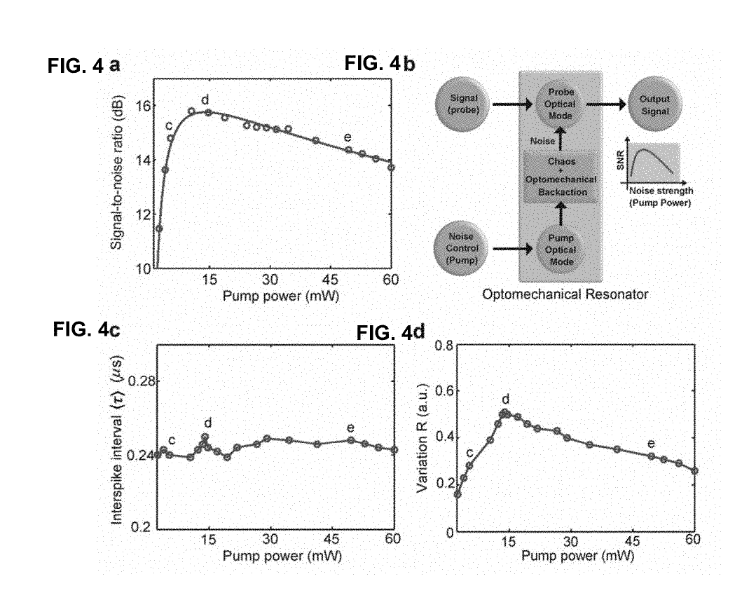

The technology as disclosed and claimed demonstrates stochastic resonance mediated by opto-mechanically-induced-chaos. Referring to FIGS. 4a through 4d, Opto-mechanically induced chaos-mediated stochastic resonance in an opto-mechanical resonator is illustrated. Referring to FIG. 4a, signal-to-noise ratio (SNR) of the probe as a function of the pump power is illustrated. The solid curve is the best fit to the demonstrated data (open circles). Referring to FIG. 4b, an illustration conceptualizing chaos-mediated stochastic resonance in an opto-mechanical resonator is provided. The mechanical motion mediates the pump-probe coupling and enables the pump field to control chaos, the strength of the opto-mechanical back-action, and the probe bandwidth. Hence, the pump controls the system's noise, where increasing the pump power first increases the SNR to its maximum and then reduces it. FIG. 4c, illustrates a Mean <τ>, and FIG. 4d, a scaled standard deviation R of interspike intervals τ, obtained from experimental data for the probe (open circles) as a function of pump power, exhibiting the theoretically-expected characteristics for a system with stochastic resonance. The data points labelled as c, d and e correspond to the same points indicated in FIG. 3.

The technology as disclosed and claimed herein demonstrates that below a critical value, increasing the pump power increases the signal-to-noise ratio (SNR) of both the probe and the pump fields; however, beyond this value, the SNR decreased despite increasing pump power (FIG. 4a). When the pump is turned off (Pₚᵤₘₚ˜0 mW), the SNR of the probe signal is −10 dB. The maximum value of the SNR is obtained for the pump power of Pₚᵤₘₚ˜15 mW. The relation between the pump power and the SNR of the probe is given by the expression (ϵ/Pₚᵤₘₚ)exp(−β1\sqrt{Pₚᵤₘₚ}), with ϵ=0.825 mW and β=7.4764 mW^{1/2}. Combining the relation between the bandwidth and the pump power with the relation between the SNR and pump power, it is determined that the relation between the SNR and the bandwidth of the probe signal scales as SNR ∝ aD⁻² exp (−b/D). This expression implies that SNR is not a monotonous function of the bandwidth D (i.e., noise), and that it is possible to increase the SNR by increasing the noise. This effect is referred to as stochastic resonance, which is a phenomenon in which the response of a nonlinear system to a weak input signal is optimized by the presence of a particular level of stochastic noise, i.e., the noise-enhanced response of an input signal. FIG. 4b provides a conceptual illustration of the mechanism leading to chaos-mediated stochastic resonance in our opto-mechanical system.

An observed noise benefit (FIG. 4a) can be described as stochastic resonance if the input (weak signal) and output signals are well-defined. When the technology is demonstrated, the input is given by the weak probe field (in the 980 nm band), and the output is the signal detected in the probe mode at the end of the fiber taper. In the rotated frame, and with the elimination of mechanical degrees of freedom, the optical system is described by a weak periodic input (i.e., the weak probe field) modulated by the frequency of the mechanical mode. The noise required for stochastic resonance can be either external or internal (due to the system internal dynamics). When demonstrating the present technology it is provided by both the opto-mechanical backaction and chaotic dynamics, which are both controlled by the external pump field.

At low pump powers, corresponding to periodic or less-chaotic regimes (i.e., negative or zero Lyapunov exponent), the contribution of the backaction noise is small, and chaos is not strong enough to help amplify the signal. Therefore, the SNR is low. At much higher pump power levels, the system evolves out of chaos. At the same time, the noise contribution to the probe from the opto-mechanical backaction increases with increasing pump power and becomes comparable to the probe signal. Consequently, the SNR of the probe decreases. Between these two SNR minima, the noise attains the optimal level to amplify the signal coherently with the help of intermode interference due to the chaotic map; and thus an SNR maximum occurs. Indeed, resonant jumps between different attractors of a system due to chaos-mediated noise as a route to stochastic resonance and to improve SNR.

The mean (τ) (FIG. 4c) and scaled standard deviation R=\sqrt{ [symbol]τ² [symbol] − [symbol] τ [symbol] ²}/τ (FIG. 4d) of the interspike intervals τ of the signals detected during the demonstration of the technology exhibit the theoretically-expected dependence on the noise (i.e., pump power) for a system with stochastic resonance. While (τ) is not affected by the pump power and retains its value of 0.24 μs (the resonance revival frequency of 26 MHz determined by the frequency of the mechanical mode), R attains a maximum at an optimal pump power (i.e., R is a concave function of noise). On the other hand, for a system with coherence resonance, increasing noise leads to a decrease in (τ), and R is a convex function of the noise. It is known that in a system with coherence resonance the positions of the resonant peaks in the output spectra shift with increasing pump power, implying that the resonances are induced solely by noise. The resonant peak in our experimentally-obtained output power spectra, however, was located at the frequency of the mechanical mode, which modulated the input probe field, and its position did not change with increasing pump power (i.e., noise level), providing another signature of stochastic resonance. Thus, it can be concluded that the observed SNR enhancement is due to the chaos-mediated stochastic resonance, and hence the present technology constitutes the first observation of opto-mechanically-induced chaos-mediated stochastic resonance, which is a counterintuitive process where additional noise can be helpful.

The technology as disclosed and claimed demonstrates a bifurcation process and the route to chaos of the probe fields follow the route to chaos of the pump. When under test, the technology demonstrated a mechanical mode with a frequency of around 26 MHz, and the evolution of this mode as a function of the power of the input pump field.

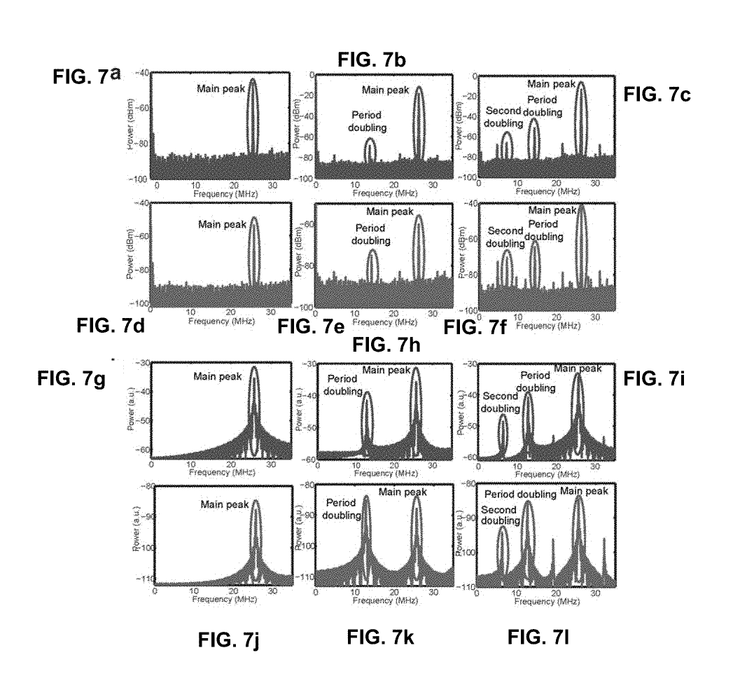

Referring to FIG. 7, opto-mechanically-induced period-doubling in the pump and probe fields is illustrated. FIG. 7a illustrates test data for the technology under test, and FIG. 7b illustrates the results of numerical simulations showing first and second period-doubling processes for the pump (Lower spectra) and probe (Upper spectra) fields. The technology in one of various implementations as disclosed demonstrates a mechanical mode with a frequency of around 26 MHz, and demonstrates the evolution of this mode as a function of the power of the input pump field. As shown in FIG. 7a, both the pump and probe fields experience a period-doubling bifurcation as the input power of the pump field is increased. When the input pump power is low, the spectra of the pump and probe fields shows a peak at around 26 MHz. When the input pump power is increased above a critical value, a second peak appears just at half frequency of the main peak, i.e., ˜13 MHz which corresponds to a period-doubling process. At higher powers, successive period-doubling events occur, leading to peaks located at frequencies of ½″-th of the main peak. For example, the second period-doubling bifurcation leads to frequency peaks at 6.5 MHz for both the pump and the probe fields.

In FIG. 7b, the results of numerical simulations obtained is illustrated by solving the following set of equations

\dot{a}ₚᵤₘₚ=−[γₚᵤₘₚ−i(Δₚᵤₘₚ−gₚᵤₘₚX)]aₚᵤₘₚ+iκϵₚᵤₘₚ(t), (S14)

\dot{a}_{probe}=−[γ_{probe}−i(Δ_{probe}−g_{probe}X)]a_{probe}+iκϵ_{probe}(t), (S15)

\dot{X}=−ΓₘX+ΩₘP, (S16) 2

\dot{P}=−ΓₘP−ΩₘX+gₚᵤₘₚ|aₚᵤₘₚ|², (S17)

which describe the evolution of the pump and probe cavity modes and the mechanical mode. In a simulation, a single mechanical eigenmode with frequency 26 MHz can be considered, similar to what is demonstrated by the technology under test. Here, Ωₘ and Γₘ are the frequency and damping rate of the mechanical mode. The probe signal is chosen to be very weak, so that it does not induce mechanical or thermal oscillations. Consequently, the mechanical mode was induced only by the pump field as described by the expression in Eq. (S17). The model explains the observations of the technology. It is clearly seen that the probe field follows the pump field during the bifurcation process.

As shown in FIGS. 7a-7l the technology demonstrates the existence of a second mechanical mode with frequency 5 MHz. This mode is excited when the pump power was increased to observe the second period-doubling process. Generally, one may think that this low-frequency mechanical mode would affect the bifurcation process of the 26 MHz mechanical mode, because these two mechanical modes are in the same micro-resonator and thus may couple to each other. However, the technology as disclosed does not demonstrate such a characteristic. Numerical simulations using COMSOL demonstrate that the mechanical modes at 26 MHz and 5 MHz are, respectively, transverse and longitudinal modes (FIG. 7c, 7d). Thus, they are orthogonal, which implies that there is minimal or no interaction between them.

Referring to FIGS. 7m and 7n a COMSOL simulation of the mechanical modes in a microtoroid is illustrated. The mechanical mode with frequency a, 26 MHz is a transverse mode whereas the one with frequency b, 5 MHz is a longitudinal mode. Both of these mechanical modes are observed, with the 5 MHz mode being excited only when the pump power is significantly high that the mode at 26 MHz experiences the second period doubling (FIG. 7a through 7l). The orthogonality of these mechanical modes implies that there is no direct coupling between them.

In order to understand how the co-existence of the pump and probe fields in the same opto-mechanical resonator affect their interaction with the system and with each other, consider the following Hamiltonian

$$H = {Δ}_{probe} {a}_{probe}^{†} {a}_{probe} + {ɛ}_{probe} ( {a}_{probe}^{†} + {a}_{probe} ) + {g}_{probe} {a}_{probe}^{†} {a}_{probe} X + \frac{{Ω}_{m}}{2} ( {X}^{2} + {P}^{2} ) + {Δ}_{pump} {a}_{pump}^{†} {a}_{pump} + {κɛ}_{pump} ( {a}_{pump}^{†} + {a}_{pump} ) + {g}_{pump} {a}_{pump}^{†} {a}_{pump} X , \qquad ( S18 )$$

where the first (fourth) and second (fifth) terms are related to the free evolution of the probe a_{probe} (pump aₚᵤₘₚ) field, and the third (sixth) term explains the interaction of the probe (the pump) field with the mechanical mode X. The last term corresponds to the free evolution of the mechanical mode.

First, consider only the probe field by eliminating the fourth, fifth and sixth terms. In this case, resulting at the Hamiltonian

$$H = {Δ}_{probe} {a}_{probe}^{†} {a}_{probe} + {κɛ}_{probe} ( {a}_{probe}^{†} + {a}_{probe} ) + {g}_{probe} {a}_{probe}^{†} {a}_{probe} X + \frac{{Ω}_{m}}{2} ( {X}^{2} + {P}^{2} ) . \qquad ( S19 )$$

By introducing the translational transformation

$${X}^{⋒} = X + \frac{{g}_{probe}}{{Ω}_{m}} {a}_{probe}^{†} {a}_{probe} , {P}^{⋒} = P , \qquad ( S20 )$$

the Hamiltonian H can be re-expressed as

$$H = {Δ}_{probe} {a}_{probe}^{†} {a}_{probe} + κ {ɛ}_{probe} ( {a}_{probe}^{†} + {a}_{probe} ) - \frac{{g}_{probe}^{2}}{2 {Ω}_{m}} {( {a}_{probe}^{†} {a}_{probe} )}^{2} + \frac{{Ω}_{m}}{2} ( {{X}^{2}}^{⋒} + {{P}^{⋒}}^{2} ) , \qquad ( S21 )$$

where we see that the nonlinear interaction between the probe field and the mechanical motion leads to an effective Kerr-like nonlinearity in the optical mode a_{probe}, with its coefficient given as

$${μ}_{probe} = \frac{{g}_{probe}^{2}}{2 {Ω}_{m}} , \qquad ( S22 )$$

where Ωₘ is the frequency of the mechanical mode. Equation (S22) implies that the opto-mechanically-induced Kerr-like nonlinearity is dependent on (i) the opto-mechanical coupling between the optical and mechanical modes and (ii) the frequency of the mechanical mode.

Following a similar procedure, we can derive the coefficient of nonlinearity for the case when only the pump field is present. In such a case, resulting in

$$H = {Δ}_{pump} {a}_{pump}^{†} {a}_{pump} + κ {ɛ}_{pump} ( {a}_{pump}^{†} + {a}_{pump} ) + {g}_{pump} {a}_{pump}^{†} {a}_{pump} X + \frac{{Ω}_{m}}{2} ( {X}^{2} + {P}^{2} ) . \qquad ( S23 )$$

By introducing the transformation

$${X}^{⋒} = X + \frac{{g}_{pump}}{{Ω}_{m}} {a}_{pump}^{†} {a}_{pump} , {P}^{⋒} = P , \qquad ( S24 )$$

the Hamiltonian rewritten as

$$H = {Δ}_{pump} {a}_{pump}^{†} {a}_{pump} + κ {ɛ}_{pump} ( {a}_{pump}^{†} + {a}_{pump} ) - \frac{{g}_{pump}^{2}}{2 {Ω}_{m}} {( {a}_{pump}^{†} {a}_{pump} )}^{2} + \frac{{Ω}_{m}}{2} ( {{X}^{⋒}}^{2} + {{P}^{⋒}}^{2} ) . \qquad ( S25 )$$

Thus, the coefficient of the effective Kerr-like nonlinearity in the optical mode aₚᵤₘₚ becomes

$${μ}_{pump} = \frac{{g}_{pump}^{2}}{2 {Ω}_{m}} , \qquad ( S26 )$$

where Ωₘ is the frequency of the mechanical mode and gₚᵤₘₚ is the strength of the coupling between the pump and mechanical modes.

Now let us consider the case where both the pump and probe fields exist within the same resonator and they are coupled to the same mechanical mode. In this case, by applying the transformation

$$\tilde{X} = X + \frac{{g}_{probe}}{{Ω}_{m}} {a}_{probe}^{†} {a}_{pump} , + \frac{{g}_{pump}}{{Ω}_{m}} {a}_{pump}^{†} {a}_{pump} , \tilde{P} = P , \qquad ( S27 )$$

re-express the Hamiltonian given in Eq. (S18) as

$$H = {Δ}_{probe} {a}_{probe}^{†} {a}_{probe} + κ {ɛ}_{probe} ( {a}_{probe}^{†} + {a}_{probe} ) - \frac{{g}_{probe}^{2}}{2 {Ω}_{m}} {( {a}_{probe}^{†} {a}_{probe} )}^{2} + \frac{{Ω}_{m}}{2} ( {\tilde{X}}^{2} + \tilde{{P}^{2}} ) + {Δ}_{pump} {a}_{pump}^{†} {a}_{pump} + κ {ɛ}_{pump} ( {a}_{pump}^{†} + {a}_{pump} ) - \frac{{g}_{pump}^{2}}{2 {Ω}_{m}} {( {a}_{pump}^{†} {a}_{pump} )}^{2} - \frac{{g}_{pump} {g}_{probe}}{{Ω}_{m}} ( {a}_{probe}^{†} {a}_{probe} ) ( {a}_{pump}^{†} {a}_{pump} ) . \qquad ( S28 )$$

Here the third and seventh terms are the coefficients of the Kerr-like nonlinearity derived earlier for the cases when only the probe or the pump fields exist in the opto-mechanical resonator. The last term, on the other hand, is new and implies an effective interaction between the pump and probe fields, if they both exist in the opto-mechanical resonator.

The dynamical equations of this system can be written as

\dot{a}ₚᵤₘₚ=−[γₚᵤₘₚ−i(Δₚᵤₘₚ−gₚᵤₘₚX)]aₚᵤₘₚ+iκϵₚᵤₘₚ, (S29)

\dot{a}_{probe}=−[γ_{probe}−i(Δ_{probe}−g_{probe}X)]a_{probe}+iκϵ_{probe}. (S30)

In the long-time limit (i.e., steady-state), we have \dot{a}ₚᵤₘₚ, \dot{a}_{probe}≈0, which leads to

$$\begin{matrix}{a}_{probe} = \frac{i κ {ɛ}_{probe}}{{γ}_{probe} - i ( {Δ}_{probe} - {g}_{probe} X )} \approx \frac{i {κɛ}_{probe}}{{γ}_{probe} - i {Δ}_{probe}} + \frac{{κɛ}_{probe} {g}_{probe}}{{( {γ}_{probe} - i {Δ}_{probe} )}^{2}} X , \\ & ( S31 ) \\ {a}_{pump} = \frac{i κ {ɛ}_{pump}}{{γ}_{pump} - i ( {Δ}_{pump} - {g}_{pump} X )} \approx \frac{i κ {ɛ}_{pump}}{{γ}_{pump} - i {Δ}_{pump}} + \frac{κ {ɛ}_{pump} {g}_{pump}}{{( {γ}_{pump} - i {Δ}_{pump} )}^{2}} X . & ( S32 )\end{matrix}$$

If we further eliminate the degrees of freedom of the mechanical mode X from the above equations, then, under the conditions that γₚᵤₘₚ=γ_{probe}, Δₚᵤₘₚ=Δ_{probe}, and gₚᵤₘₚ=g_{probe}, we have

aₚᵤₘₚ=(ϵₚᵤₘₚ/ϵ_{probe})α_{probe}. (S33)

By substituting this equation into the last term in Eq. (S28), we see that the last term of the Hamiltonian becomes

$$\frac{{g}_{pump} {g}_{probe}}{{Ω}_{m}} ( {a}_{probe}^{†} {a}_{probe} ) ( {a}_{pump}^{†} {a}_{pump} ) \to \frac{{g}_{pump} {g}_{probe} {ɛ}_{pump}^{2}}{{Ω}_{m} {ɛ}_{probe}^{2}} {( {a}_{probe}^{†} {a}_{probe} )}^{2} , \qquad ( S34 )$$

from which we define the coefficient of nonlinearity as

$${\tilde{μ}}_{probe} = \frac{{g}_{probe}^{2} {ɛ}_{pump}^{2}}{{Ω}_{m} {ɛ}_{probe}^{2}} . \qquad ( S35 )$$

It is clear that even a very weak probe field can experience a strong Kerr nonlinearity, and hence a nonlinear dynamics, if the intensity of the pump is sufficiently strong. Thus, the system intrinsically enables an opto-mechanically-induced Kerr-like nonlinearity, which helps the optical pump and probe fields interact with each other. It is clear that the strength of the interaction can be made very high by increasing the ratio of the intensity of the input pump field ϵₚᵤₘₚ² to that of the input probe field ϵ_{probe}². With the configuration of the technology as tested, the pump field is at least three-orders of magnitude larger than the probe field. Thus the nonlinear coefficient \tilde{μ}_{probe} given in Eq. (S35) is increased by at least three-orders of magnitude, compared to the nonlinear coefficient μ_{probe} given in Eq. (S22).

The trajectory of the mechanical motion can be estimated from the demonstration data. The mechanical mode excited in the microtoroid during the demonstration has a frequency of Ωₘ=26.1 MHz and a damping rate of Γₘ=0.2 MHz, implying a quality factor of Qₘ≈130 These values are used in the nonlinear opto-mechanical equations to reconstruct the mechanical motion. It is seen that the opto-mechanical resonator experiences a periodic motion (FIG. S5a) even when the detected optical pump field showed chaotic behavior. To explain this, we start from the following equation for the mechanical resonator

\dot{X}=−ΓₘX+ΩₘP, (S36)

\dot{P}=−ΓₘP−ΩₘX+gₚᵤₘₚI(t), (S37)

where P is the momentum of the mechanical mode and I(t)=|aₚᵤₘₚ(t)|² is the intensity of the pump with the field amplitude aₚᵤₘₚ. By introducing the complex amplitude

b=(X+iP)/\sqrt{2}, Eqs. (S36) and (S37) can be rewritten as

\dot{b}=−(Γₘ−iΩₘ)b+gₚᵤₘₚl(t). (S38)

The above equation can be solved in the frequency domain as

$$b ( ω ) = \frac{{g}_{pump}}{i ( ω - {Ω}_{m} ) + {Γ}_{m}} I ( ω ) , \qquad ( S39 )$$

from which we obtain

$$\begin{matrix}{S}_{b} ( ω ) = {\vert b ( ω ) \vert}^{2} = \frac{{g}_{pump}^{2}}{{( ω - {Ω}_{m} )}^{2} + {Γ}_{m}^{2}} {\vert I ( ω ) \vert}^{2} = \frac{{g}_{pump}^{2}}{{Γ}_{m}^{2}} {𝒳}_{b I} ( ω ) {S}_{I} ( ω ) , & ( S40 ) \\ Where & \\ {𝒳}_{bI} ( ω ) = \frac{{Γ}_{m}^{2}}{{( ω - {Ω}_{m} )}^{2} + {Γ}_{m}^{2}} & ( S41 )\end{matrix}$$

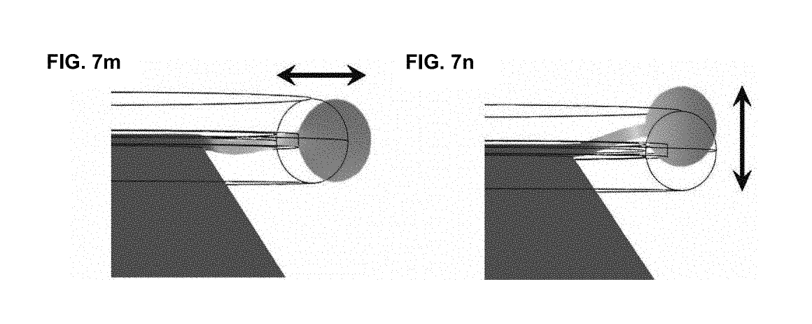

is the susceptibility coefficient induced by the mechanical resonator and S_{I}(ω)=|I(ω)|² is the spectrum of I(t). As shown in FIG. 8a, the mechanical resonator works similar to a low-pass filter, which filters out the high-frequency components of I(t). In fact, the susceptibility coefficient X_{bI}(ω) modifies the shape of S_{I} (ω) and shrinks the spectrum S_{b}(ω) to the low-frequency regime. By such a filtering process, the mechanical motion of the resonator does not experience the high-frequency components typical of chaotic behavior, but instead remains in the periodic-oscillation regime, as shown in the reconstructed motion of the mechanical mode in FIG. 8b. FIG. 8 illustrates a reconstructed mechanical motion of the microtoroid resonator. FIG. 8a, illustrates periodic mechanical motion of the microtoroid when the pump and probe fields are both in the chaotic regime. FIG. 8b, illustrates filtering by the mechanical resonator where the mechanical resonator works as a low-pass filter which filters out the high-frequency components in the mechanical modes.

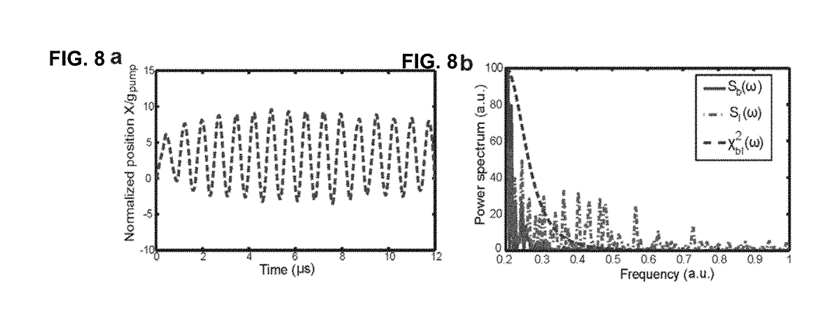

Lyapunov exponents quantify sensitivity of a system to initial conditions and give a measure of predictability. They are a measure of the rate of convergence or divergence of nearby trajectories. A positive exponent implies divergence and that the orbits are on a chaotic attractor. A negative exponent implies convergence to a common fixed point. Zero exponent implies that the orbits maintain their relative positions and they are on a stable attractor. The present technology as disclosed shows how the pump power affects the maximum Lyapunov exponent of the pump and probe fields. In FIG. 9, numerical results are presented regarding the effect of the frequency detuning between the cavity resonance and the pump, frequency detuning between the cavity resonance and the probe, and the damping rates of the pump and probe on the maximum Lyapunov exponent. As seen in FIG. 9a, Lyapunov exponents of the pump and probe fields vary with increasing frequency detuning between the pump and the cavity resonance. As the frequency detuning of the pump increases, Lyapunov exponent increases from negative to positive values, attaining its maximum value at a detuning value of Δₚᵤₘₚ≈0.9 Ωₘ. With further increase of detuning, it decreases and returns back to negative values. Thus, with increasing detuning of the pump from the cavity resonance, the system evolves first to chaotic regime and then gets out of chaos into a periodic dynamics.

This is similar to the behavior observed for the varying pump field. Interestingly, both the pump and probe fields follow the same dependence on the pump-cavity detuning. When examining the effect of probe-cavity detuning (FIG. 9b), It can be determined that varying probe-cavity detuning affects only the maximum Lyapunov exponent of the probe, and the pump Lyapunov exponent is not affected. The reason for this is that in the demonstration of the technology and in these simulations, the power of the probe field is kept sufficiently weak that it does not affect the pump field. A similar trend is seen in the case of varying the damping rates of the pump and probe modes, that is varying the damping rate of the pump affects Lyapunov exponents of both the pump and probe (FIG. 9c) but varying the damping rate of the probe affects only the Lyapunov exponent of the probe (FIG. 9d). FIG. 9c shows that with increasing damping rate the maximum Lyapunov exponent decreases from a positive value down to negative values. This can be explained as follows. Increasing damping rate, decreases the quality factor of the resonator which in turn reduces the intracavity field intensity. As a result optomechanical oscillation is gradually suppressed and the degree of the chaos induced by optomechanical interaction decreases.

FIG. 9 illustrates the maximum of the Lyapunov exponent for the pump (Upper spectra) and probe (Lower spectra) fields. FIG. 9a illustrates the effect of the pump-cavity detuning, 9b, the effect of probe-cavity detuning, 9c, the effect of the damping rate of the pump, and for FIG. 9d the effect of damping rate of the probe on the maximum Lyapunov exponents of the pump and probe fields.

In order to further illustrate the stochastic resonance phenomenon, first, focus on the dynamics of the optical mode coupled to the probe field a_{probe}. The total Hamiltonian of the optical modes aₚᵤₘₚ, a_{probe}, and the mechanical mode can be written as in Eq. (S18). By introducing the translation transformation in Eq. (S27) and getting rid of the degrees of freedom of the mechanical mode and the optical mode coupled to the pump field aₚᵤₘₚ, the Hamiltonian in Eq. (S18) can be re-expressed as

H=Δ_{probe}a_{probe}^{†}a_{probe}+κϵ_{probe}(a_{probe}^{†}+a_{probe})−\tilde{μ}_{probe}(a_{probe}^{†}a_{probe})², (S42)

where \tilde{μ}_{probe} is given in Eq. (S35). We can see that the nonlinear opto-mechanical coupling leads to an effective fourth-order nonlinear term in the optical mode a_{probe}. Introducing the normalized position and momentum operators

$${x}_{probe} = \frac{1}{\sqrt{2}} ( {a}_{probe}^{†} + {a}_{probe} ) , {p}_{probe} = \frac{i}{\sqrt{2}} ( {a}_{probe}^{†} - {a}_{probe} ) , \qquad ( S43 )$$

we write the following dynamical equation by dropping some non-resonant terms and introducing the noise terms:

\dot{x}_{probe}=−γ_{probe}x_{probe}+ω_{probe}p_{probe}, (S44)

\dot{p}_{probe}=−Δ_{probe}x_{probe}−γ_{probe}p_{probe}+\tilde{μ}_{probe}x³+κϵ_{probe}(t)+ξ(t), (S45)

where ξ(t) is a noise term with a correlation time negligibly small when compared to the characteristic time scale of the optical modes and mechanical mode of the optomechanical resonator:

[symbol]

ξ(t)ξ(t′ [symbol] =2Dδ(t−t′), (S46)

with D denoting the strength of the noise. Subsequently, we arrive at the second-order oscillation equation

\ddot{x}_{probe}+2γ_{probe}\dot{x}_{probe}=−(Δ_{probe}²+γ_{probe}²)x_{probe}+\tilde{μ}_{probe}Δ_{probe}x_{probe}³+κΔ_{probe}ϵ_{probe}(t)+Δ_{probe}ξ(t). (S47)

Under the condition that Δ_{probe}«γ_{probe} in the overdamped limit, the above second-order oscillation equation can be reduced to

$${\dot{x}}_{probe} = - \frac{{Δ}_{probe}^{2}}{2 {γ}_{probe}} {x}_{probe} + {\tilde{μ}}_{probe} \frac{{Δ}_{probe}}{2 {γ}_{probe}} {x}_{probe} + κ \frac{{Δ}_{probe}}{2 {γ}_{probe}} {ɛ}_{probe} ( t ) + \frac{{Δ}_{probe}}{2 {γ}_{probe}} ξ ( t ) . \qquad ( S48 )$$

If introducing the normalized time unit τ=(2γ_{probe}/Δ_{probe})t, arriving at

$$\frac{d}{d τ} {x}_{probe} = - {Δ}_{probe} {x}_{probe} + {\tilde{μ}}_{probe} {x}_{probe}^{3} + κ {ɛ}_{probe} ( τ ) + ξ ( τ ) . \qquad ( S49 )$$

which is a typical equation leading to the stochastic resonance phenomenon. The signal-to-noise ratio (SNR) for such a system is given by

$$S N R = \frac{{Δ}_{probe}^{2} {Ω}_{m}^{2} {κ}^{2} {ɛ}_{probe}^{2}}{8 \sqrt{2} {D}^{2} {g}_{probe}^{4}} exp ( - \frac{{Δ}_{probe}^{2} {Ω}_{m}}{8 {g}_{probe}^{2} D} ) . \qquad ( S50 )$$

Since the strength of the noise D is related to the pump power Pₚᵤₘₚ by D=αPₚᵤₘₚ^{1/2}, the relation between the SNR and the pump power can be re-written as

$$S N R = \frac{{Δ}_{probe}^{2} {Ω}_{m}^{2} {κ}^{2} {ɛ}_{probe}^{2}}{8 \sqrt{2} {α}^{2} {P}_{pump} {g}_{probe}^{4}} exp ( - \frac{{Δ}_{probe}^{4} {Ω}_{m}}{8 {g}_{probe}^{2} α {P}_{pump}} ) , \qquad ( S51 )$$

which implies that the SNR is not a monotonous function of the pump power Pₚᵤₘₚ and hence it is possible to increase the SNR by increasing the pump power (i.e., subsequently by increasing the bandwidth D and hence the noise). Following the same procedure one can derive SNR for the pump in a straightforward way.

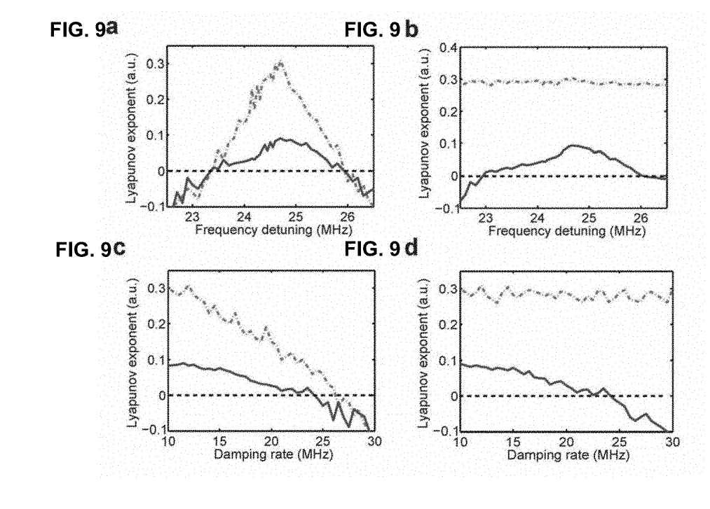

In FIG. 10, we give the SNR versus pump power for both the probe and pump fields measured in our experiments together with the best fit according to Eq. (S51) for the probe and the similar expression for the pump. Keeping ϵ and β as free parameters, we found the best fits with ϵ=0.825 mW and β=7.4764 in W^{1/2} for the probe and with ϵ=2.6388 mW and β=6.47 mW^{1/2} for the pump.

FIG. 10 illustrates the Signal-to-noise ratio (SNR) for the pump and probe signals. The technology demonstrates a signal-to-noise ratio (SNR) of the probe (blue open circles) and pump (red diamonds) signals as a function of the pump power. Solid curves are the best fits to the experimental data.

As discussed above, stochastic resonance is a phenomenon in which the response of a nonlinear system to a weak input signal is optimized by the presence of a particular level of noise, i.e., the noise-enhanced response of a deterministic input signal. Coherence resonance is a related effect demonstrating the constructive role of noise, and is known as stochastic resonance without input signal. Coherence resonance helps to improve the temporal regularity of a bursting time series signal. The main difference between stochastic resonance and coherence resonance is whether a deterministic input signal is input to the system and whether the induced SNR enhancement is the consequence of the response of this deterministic input. With at least on implementation of the present technology, a weak probe signal, which is modulated by the mechanical mode of the optomechanical resonator at the frequency Ωₘ=26 MHz, acts as a periodic input signal fed into the system. In order to confirm that the observed phenomenon in the technology as demonstrated is stochastic resonance rather than coherence resonance, numerical simulations are performed and compared the results with the present technology demonstration results. The dynamical equations used for numerical simulation are given by

\dot{a}ₚᵤₘₚ=−[γₚᵤₘₚ−i(Δₚᵤₘₚ−gₚᵤₘₚX)]aₚᵤₘₚ+iκϵₚᵤₘₚ(t)+Dₚᵤₘₚξₚᵤₘₚ(t), (S52)

\dot{a}_{probe}=−[γ_{probe}−i(Δ_{probe}−g_{probe}X)]a_{probe}+iκϵ_{probe}(t)+D_{probe}ξ_{probe}(t), (S53)

\dot{X}=−ΓₘX+ΩₘP, (S54)

\dot{P}=−ΓₘP−ΩₘX+gₚᵤₘₚ|aₚᵤₘₚ|²+Dₘξₘ(t), (S55)

with parameters Δₚᵤₘₚ/Ωₘ=Δ_{probe}/Ωₘ=1, γₚᵤₘₚ/Δₚᵤₘₚ=0.1, γ_{probe}/Δ_{probe}=0.1,

Γₘ/Ωₘ=0.01, gₚᵤₘₚ/Δₚᵤₘₚ=g_{probe}/Δ_{probe}=0.1, 78/Δₚᵤₘₚ=ϵₚᵤₘₚ/Δₚᵤₘₚ−1,

Dₚᵤₘₚ/Δₚᵤₘₚ=0.1, D_{probe}/Δ_{probe}=0.1, Dₘ/Ωₘ=0.1. ξₚᵤₘₚ(t), ξ_{probe}(t), ξₘ(t) are white noises such that

E[ξᵢ(t)]=0,E[ξᵢ(t)ξⱼ(t′)]=δᵢⱼδ(t−t′), (S56)

where E(·) is average over the noise. In the case of stochastic resonance, ϵ_{probe}/Δ_{probe}=0.1, and in the case of coherence resonance ϵ_{probe}/Δ_{probe}=0 to simulate the system with a weak probe input and without the weak probe input, respectively.

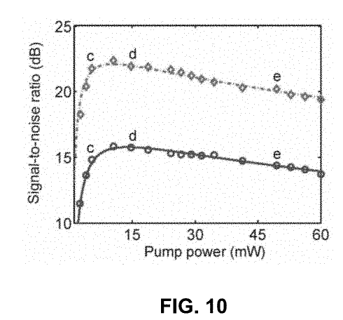

FIG. 11 illustrates an output spectra obtained in the experiments and in the numerical simulations of stochastic resonance and coherence resonance at various pump powers. FIG. 11a, illustrates an Output spectra obtained in the demonstration testing show that the spectral location of the resonance peak do not change with increasing pump power. FIG. 11b, illustrates an output spectra obtained in the numerical simulations of stochastic resonance show that the spectral location of the resonance peak stays the same for increasing pump power, similar to what was observed in the demonstration testing. FIG. 11c, illustrates an output spectra obtained in the numerical simulations of coherence resonance which show that the spectral location of the resonance peaks change with increasing pump power. From left to the right, the input pump power is increased.

The output spectra obtained from the demonstration of the technology is compared (FIG. 11a) with the results of numerical simulations where the theoretical model introduced above is considered with and without weak probe input to simulate stochastic resonance (FIG. 1b) and coherence resonance (FIG. 11c).

It is seen that in the output spectra obtained from the technology demonstration (FIG. 11a) and the simulations with weak probe input (FIG. 11b), the position of the resonant peaks are not affected by increasing pump power. The spectral position of the resonant peak in the output spectra is fixed at the frequency of the periodic input signal. However, for the case, with no weak probe input, simulating coherence resonance, the positions of the resonant peaks in the output spectra shift with increasing pump power, implying that the resonances are induced by noise. Thus, the behavior of the resonances in the output spectra obtained in the demonstration testing agrees with what one would expect for stochastic resonance, and it is completely different that what one would expect for coherence resonance.

Next, the mean interspike intervals are compared and its scaled standard deviation calculated from the output signal measured in our experiments with the results of numerical simulations of the technology in the one or more implementations disclosed when a weak probe field is used as an input (case of stochastic resonance) and when there is no input probe field (case of coherence resonance). The interspike interval is defined as the mean time between two adjacent spikes in the time-domain output signals,

$$〈 τ 〉 = {lim}_{N \to ∞} \frac{1}{N} {\sum }_{i = 1}^{N} {τ}_{i} , \qquad ( S .57 )$$

where τᵢ is the time between the i-th and (i+1)-th spikes. The variation R of the interspike intervals which is defined as the scaled standard devistion of the mean interspike interval is given as

$$R = \frac{\sqrt{〈 {τ}^{2} 〉 - {〈 τ 〉}^{2}}}{〈 τ 〉} . \qquad ( S .58 )$$

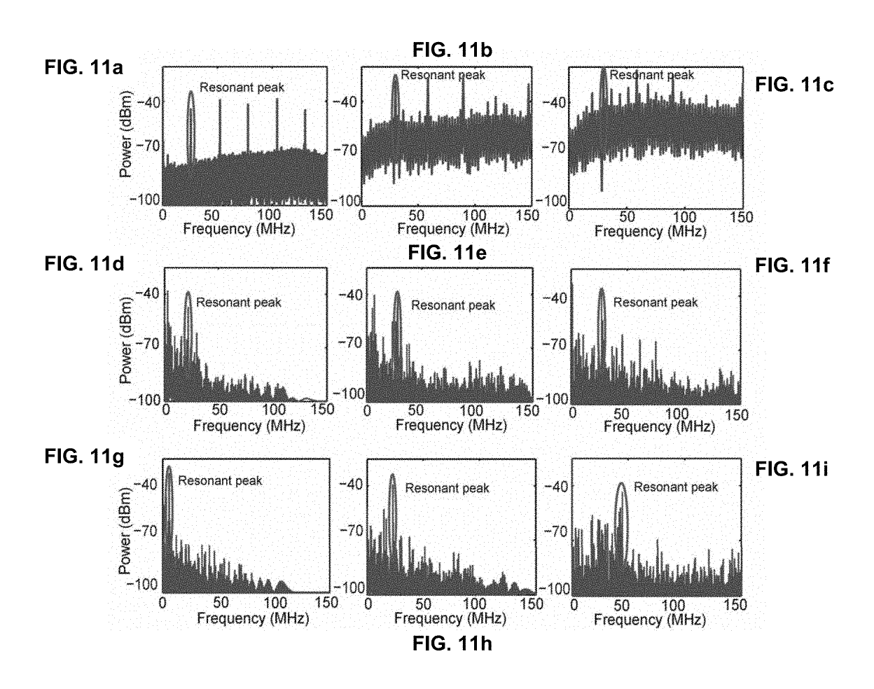

FIG. 12 illustrates a mean interspike interval and its variation for the probe mode. FIG. 12a, illustrates a mean interspike interval and its variation calculated from the output signal in the probe mode obtained in the experiments. FIG. 12b, illustrates a mean interspike interval and its variation obtained in the numerical simulation of stochastic resonance in our system (with input weak probe). FIG. 12c illustrates a mean interspike interval and its variation obtained in the numerical simulation of coherence resonance in our system (without input weak probe). Experimental results agree well with the simulation results of stochastic resonance, and demonstrate a completely different dynamics than the coherence resonance. This imply that the observed phenomenon in the experiments is stochastic resonance.

In FIG. 12, illustrates the results of the demonstration test for the technology (FIG. 12a) and the numerical simulations for stochastic resonance (FIG. 12b) and for coherence resonance (FIG. 12c). The pump power dependence of [symbol] τ [symbol] and R obtained for our experimental data and that obtained for the numerical simulation of stochastic resonance agree well, that is in both the experiments and numerical simulations we see that pump power does not affect [symbol] τ [symbol] much, and R reaches a maximum at an optimal pump power (i.e., R is a concave). From the results of the simulations of coherence resonance, we see that (i) the mean interspike interval [symbol] τ [symbol] drops gradually with increasing pump power, and (ii) R is a concave function, exhibiting a minimum at an optimal pump power. The very good agreement between what is observed in the technology demonstration testing and the results of the numerical simulations of stochastic resonance in the theoretical model describing the present technology strongly supports that observed in the experiments is stochastic resonance rather than coherence resonance.

The various implementations of chaos induced stochastic resonance in opto-mechanical systems as shown above illustrate a novel system and method for opto-mechanically mediated chaos transfer between two optical fields such that they follow the same route to chaos. A user of the present technology as disclosed may choose any of the above implementations, or an equivalent thereof, depending upon the desired application. In this regard, it is recognized that various forms of the subject of chaos induced stochastic resonance in opto-mechanical system could be utilized without departing from the scope of the present invention.

**Chirality lies at the heart of the most fascinating and fundamental phenomena in modern physics like the quantum Hall effect, Majorana fermions and the surface conductance in topological insulators as well as in p-wave superconductors. In all of these cases chiral edge states exist, which propagate along the surface of a sample in a specific direction. The chirality (or handedness) is secured by specific mechanisms, which prevent the same edge state from propagating in the opposite direction. For example, in topological insulators the backscattering of edge-states is prevented by the strong spin-orbit coupling of the underlying material.

Transferring such concepts to the optical domain is a challenging endeavor that has recently attracted considerable attention. Quite similar to their electronic counterparts, the electromagnetic realizations of chiral states typically require either a mechanism that breaks time-reversal symmetry or one that gives rise to a spin-orbit coupling of light. Since such mechanisms are often not available or difficult to realize, alternative concepts have recently been proposed, which require, however, a careful arrangement of many optical resonators in structured arrays. Here we demonstrate explicitly that the above demanding requirements on the realization of chiral optical states propagating along the surface of a system can all be bypassed by using a single resonator with non-Hermitian scattering. The key insight in this respect is that a judiciously chosen non-Hermitian out-coupling of two near-degenerate resonator modes to the environment leads to an asymmetric backscattering between them and thus to an effective breaking of the time-reversal symmetry that supports chiral behaviour. More specifically, we show that a strong spatial chirality can be imposed on a pair of WGMs in a resonator in the sense of a switchable direction of rotation inside the resonator such that they can be tuned to propagate in either the clockwise (cw) or the counterclockwise (ccw) direction.

In our experiment we achieved this on-demand tunable modal chirality and directional emission using two scatterers placed in the evanescent field of a resonator. When varying the relative positions of the scatterers the modes in the resonator change their chirality periodically reaching maximal chirality and unidirectional emission at an exceptional point (EP) a feature which is caused by the non-Hermitian character of the system.

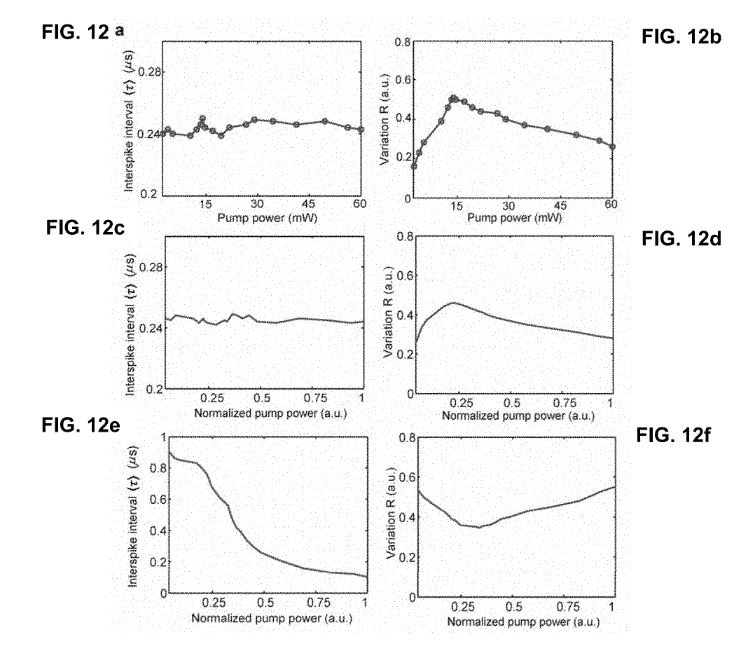

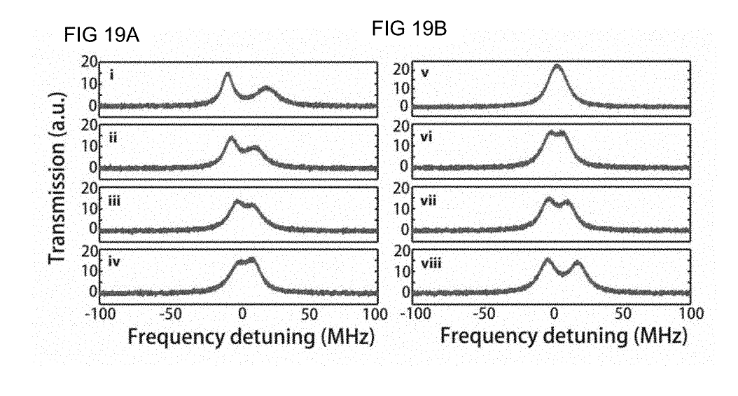

FIG. 13, illustrated the experimental configuration used in the technology and the effect of scatterers. (A) Illustration of a WGM resonator side-coupled to two waveguides, with the two scatterers enabling the dynamical tuning of the modes. cw and ccw are the clockwise and counterclockwise rotating intracavity fields. a_{cw(ccw)} and b_{cw(ccw)} are the field amplitudes propagating in the waveguides. β: relative phase angle between the scatterers. (B) Varying the size and the relative phase angle of a second scatterer helps to dynamically change the frequency detuning (splitting) and the linewidths of the split modes revealing avoided crossings (top panel) and an EP (lower panel). (C) Effect of β on the frequency splitting 2 g, difference γ_{diff} and sum γₛᵤₘ of the linewidths of split resonances when relative size of the scatterers were kept fixed (FIG. 19-21).

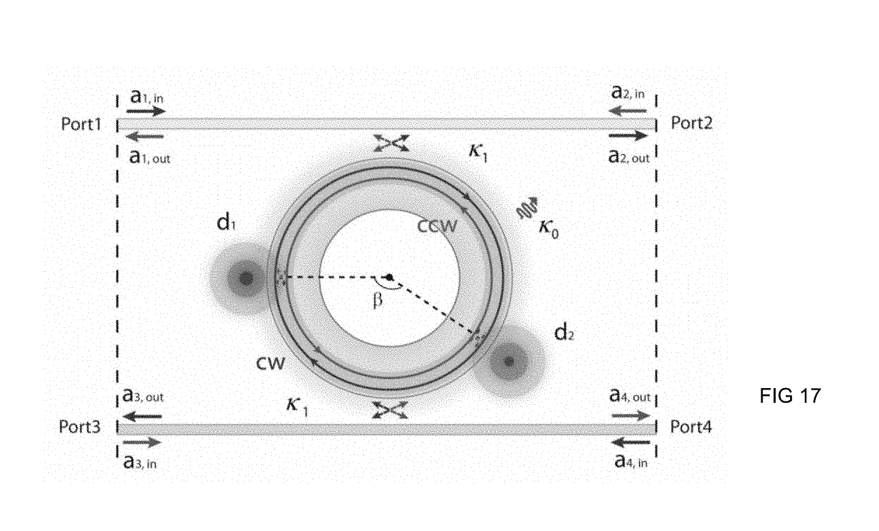

The setup consists of a silica microtoroid WGM resonator that allows for the in- and out-coupling of light through two single-mode waveguides (FIG. 13A and 17). The resonator had a quality factor Q˜3.9×10⁷ at the resonant wavelength of 1535.8 nm. To probe the scattererinduced chirality of the WGMs, and to simulate scatterers we used two silica nanotips whose relative positions (i.e., relative phase angle β) and sizes within the evanescent field of the WGMs were controlled by nanopositioners.

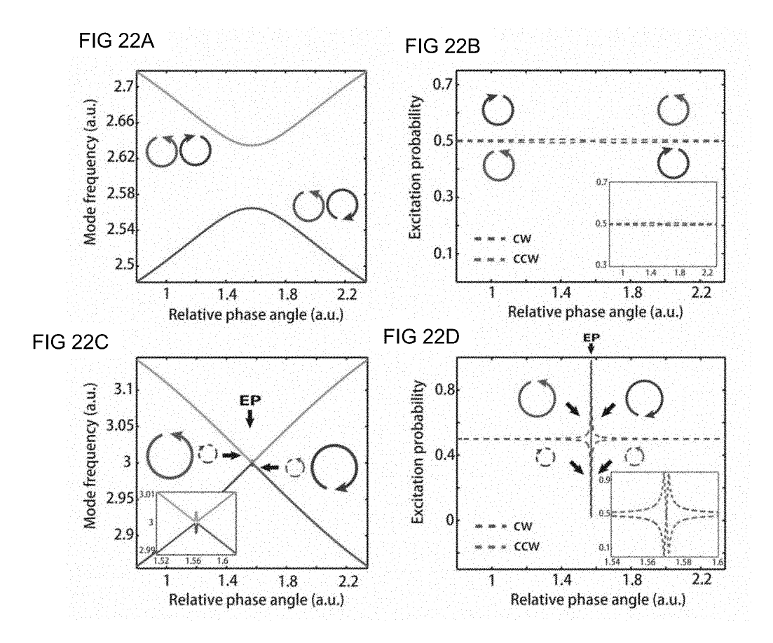

First, using only the waveguide with ports 1 and 2 (FIG. 13A), we determined the effect of the sizes and positions of the scatterers on the transmission spectra. With the first scatterer entering the mode volume, we observed frequency splitting in the transmission spectra due to scattererinduced modal coupling between the cw and ccw travelling modes. Subsequently, the relative position and the size of the second scatterer were tuned to bring the system to an EP (FIGS. 13, B and C, and 18-21) which is a non-Hermitian degeneracy identified by the coalescence of the complex frequency eigenvalues and the corresponding eigenstates. EP acts as a veritable source of non-trivial physics in a variety of systems. Depending on the amount of initial splitting introduced by the first scatterer and β, tuning the relative scatterer size brought the resonance frequencies (real part of eigenvalues) closer to each other, and then either an avoided crossing or an EP was observed (FIG. 13B, 20 and 21). At the EP both the frequency splitting 2 g and the linewidth difference γ_{diff} of the resonances approach zero, whereas the sum of their linewidths mₛᵤₘ remains finite (FIG. 13C, 20 and 21). An EP does not only lead to a perfect spectral overlap between resonances, but also forces the two corresponding modes to become identical. Correspondingly, a pair of two counter-propagating WGMs observed in closed Hermitian resonators turns into a pair of co-propagating modes with a chirality that increases the closer the system is steered to the EP (FIG. 22-24).

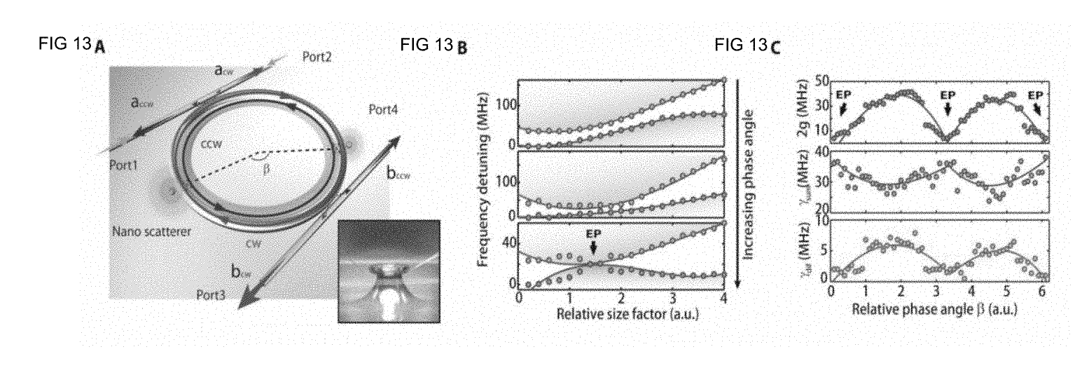

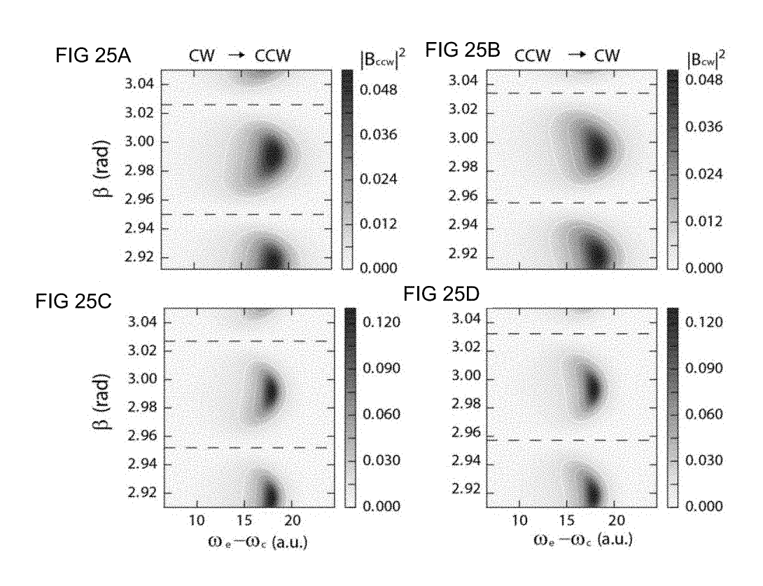

To investigate this modal chirality in detail we used both of the waveguides and monitored the transmission and reflection spectra at the output ports of the second waveguide for injection of light from two different sides of the first waveguide (FIG. 14). In the absence of the scatterers, when light was injected in the cw direction, a resonance peak was observed in the transmission and no signal was obtained in the reflection port [FIG. 14A(i)]. Similarly, when the light was injected in the ccw direction, the resonance peak was observed in the transmission port with no signal in the reflection port [FIG. 14B(i)]. When only one scatterer was introduced, two split resonance modes were observed in the transmission and reflection ports regardless of whether the signal was injected in the cw or ccw directions [FIG. 14, A(ii) and 2B(ii)], implying that the field inside the resonator is composed of modes travelling in both cw and ccw directions. When the second scatterer was introduced and its position and size were tuned to bring the system to an EP, we observed that the transmission curves for injections from two different sides were the same but the reflection curves were different [FIG. 14, A(iii) and B(iii)]: while the reflection shows a pronounced resonance peak for the ccw input, this peak vanishes for the cw input. The fact that the transmission curves for different input ports are the same follows from reciprocity, which is well-fulfilled in our system. On the other hand, the asymmetric backscattering (reflection) is the defining hallmark of the desired chiral modes, for which we provide here the first direct measurement in a microcavity (FIG. 25 and supplementary text 20).

FIG. 14. Experimental observation of scatterer-induced asymmetric backscattering. (A, B) When there is no scattering center in or on the resonator, light coupled into the resonator through the first waveguide in the cw (A(i)) [or ccw (B(i))] direction couples out into the second waveguide in the cw (A(i)) [or ccw (B(i))] direction: the resonant peak in the transmission and no signal in the reflection. A(ii), B(ii), When a first scatterer is placed in the mode field, resonant peaks are observed in both the transmission and the reflection regardless of whether the light is input in the cw (A(ii)) or in the ccw (B(ii)) directions. A(iii), B(iii), When a second scatterer is suitably placed in the mode field, for the cw input there is no signal in the reflection output port (A(iii)), whereas for the ccw input there is a resonant peak in the reflection, revealing asymmetric backscattering for the two input directions. Inset of B(iii) compares the two backscattering peaks in A(iii) and B(iii). Estimated chirality is −0.86.

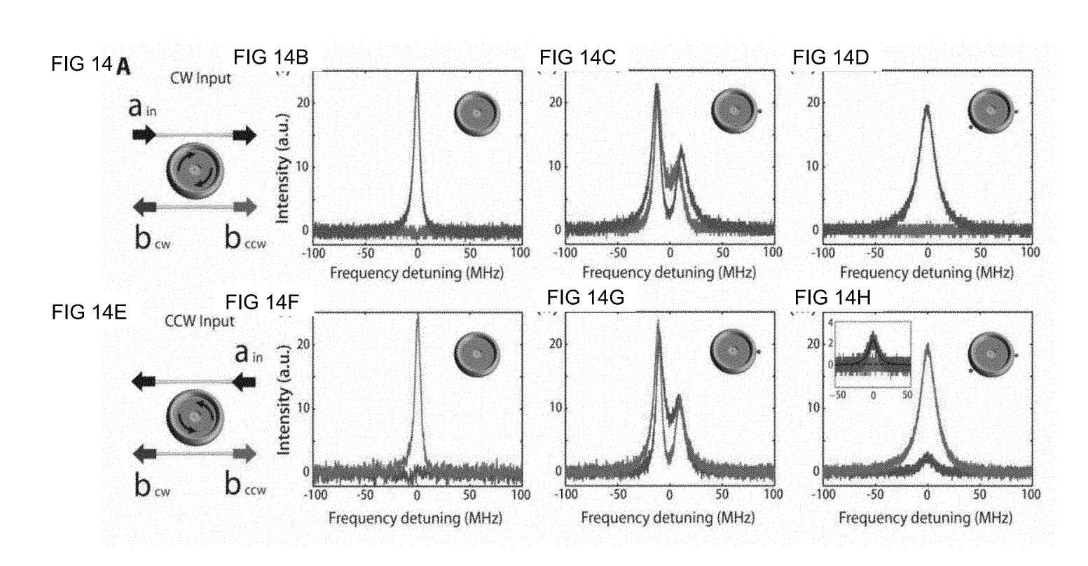

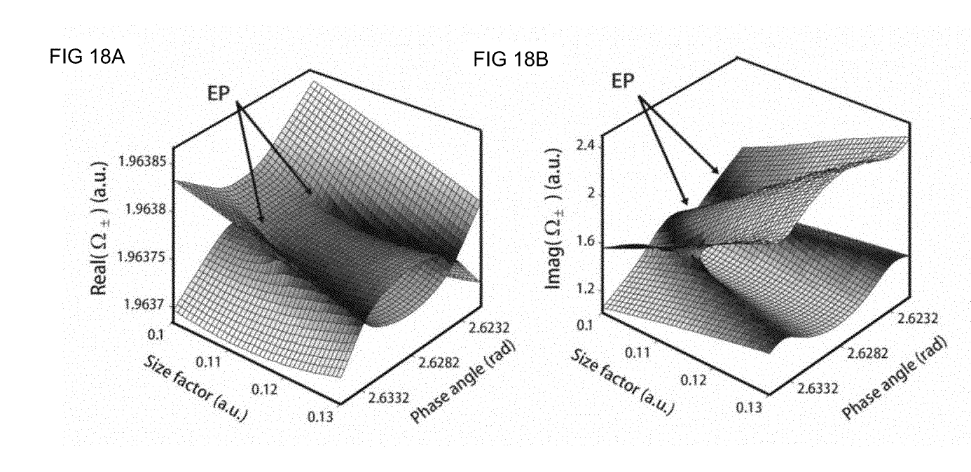

The crucial question to ask at this point is how the “chirality”—an intrinsic property of a mode that we aim to demonstrate-can be distinguished from the simple “directionality” (or sense of rotation) imposed on the light in the resonator just by the biased input. To differentiate between these two fundamentally different concepts based on the experimentally obtained transmission spectra, we determined the chirality and the directionality of the field within the WGM resonator using the following operational definitions: the directionality defined as D=(\sqrt{I_{bccw}}−\sqrt{I_{bcw}})/(\sqrt{I_{bccw}}+\sqrt{I_{bcw}}) simply compares the difference of the absolute values of the light amplitudes measured in the ccw and cw directions, irrespective of the direction from which the light is injected (FIG. 13A and 14). We observed that varying the relative distance between the scatterers changed this directionality, but the initial direction, that is the direction in which the input light was injected, remained dominant (FIG. 15A). The intrinsic chirality of a resonator mode is a quantity that is entirely independent of any input direction and therefore not as straightforward to access experimentally. One can, however, get access to the chirality a through the intensities measured in the used four-port setup as a=(\sqrt{I₁₄}−\sqrt{I₂₃})/(\sqrt{I₁₄}\sqrt{I₂₃}), where Iⱼₖ denotes the intensity of light measured at the k-th port for the input at the j-th port (FIG. 13A and 17, supplementary text 19 and 20). Note that to obtain α the reflection intensities obtained for injections from two different sides are compared. The chirality thus quantifies the asymmetric backscattering, similar to what is shown in FIG. 14A(iii) and 14B(iii). If the backscattering is equal for both injection sides (I₁₄=I₂₃) the chirality is zero, implying symmetric backscattering and orthogonal eigenstates. In the case where backscattering for injection from one side dominates, the chirality approaches 1 or −1 depending on which side is dominant. The extreme values α=±1 are, indeed, only possible when the eigenvalues and eigenvectors of the system coalesce, that is, when the system is at an EP. By changing the relative phase angle between the scatterers, we obtained quite significant values α≈±0.79 of chirality with both negative and positive signs (FIG. 15B). The strong chiralities observed in FIG. 15B are linked to the presence of two EPs, each of which can be reached by optimizing β such that asymmetric scattering is maximized for one of the two injection directions (FIGS. 18, 22, 23 and 25, supplementary text 17 and 20).

FIG. 15. Controlling directionality and intrinsic chirality of whispering-gallery-modes. (A) Directionality and (B) chirality a of the WGMs of a silica microtoroid resonator as a function of β between the two scatterers.

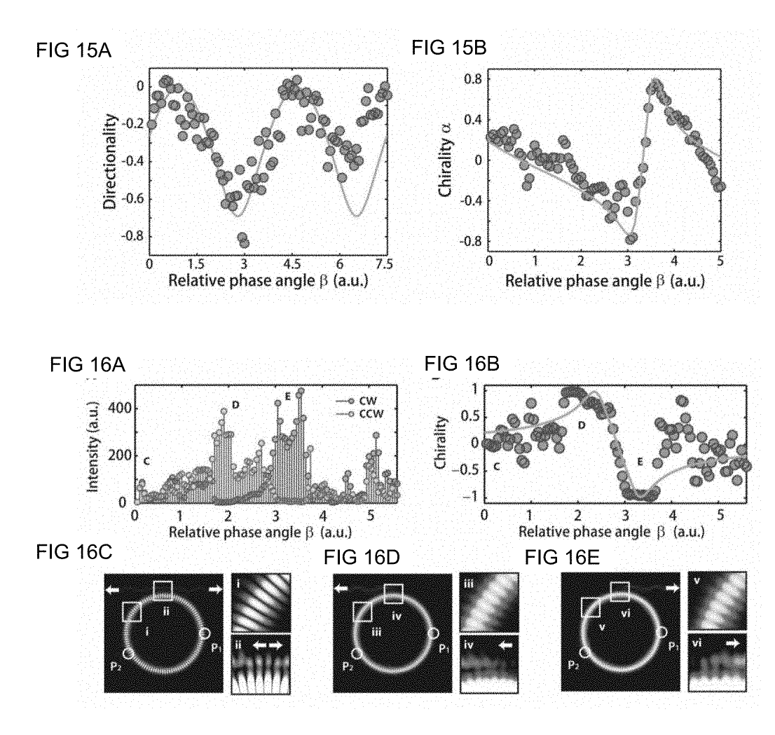

FIG. 16. Scatterer-induced mirror-symmetry breaking at an EP. In a WGM microlaser with mirror symmetry the intracavity laser modes rotate both in cw and ccw directions and thus the outcoupled light is bidirectional and chirality is zero. The scatterer-induced symmetry breaking allows tuning both the directionality and the chirality of laser modes. (A) Intensity of light out-coupled into a waveguide in the cw and ccw directions as a function of β. Regions of bidirectional emission, and fully unidirectional emission are seen. (B) Chirality as a function of β. Transitions from non-chiral states to unity (±1) chirality at EPs are clearly seen. Unity chirality regions correspond to unity unidirectional emission regions in (A). (C, D, E) Finite element simulations revealing the intracavity field patterns for the cases labeled as C, D and E in (A) and (B). Results shown in (C)-(E) were obtained for the same size factor but different β: (C) 2.628 rad; (D) 2.631 rad; and (E) 2.626 rad. P₁ and P₂ denote the locations of scatterers.

Finally, we addressed the question how this controllably induced intrinsic chirality can find applications and lead to new physics in the sense that the intrinsic chirality of the modes is fully brought to bear. The answer is to look at lasing in such devices since the lasing modes are intrinsic modes of the system. Previous studies along this line were restricted to ultrasmall resonators on the wavelength scale, where modes were shown to exhibit a local chirality and no connection to asymmetric backscattering could be established. Here we address the challenging case of resonators with a diameter being multiple times the wavelength (>50λ), for which we achieved a global and dynamically tunable chirality in a microcavity laser that we can directly link to the non-Hemitian scattering properties of the resonator. In our last set of experiments, we achieved a global and dynamically tunable chirality in a microcavity laser that we can directly link to the non-Hemitian scattering properties of the resonator. We used an Erbium (Er³⁺) doped silica microtoroid resonator coupled to only the first waveguide, which was used both to couple into the resonator the pump light to excite Er³⁺ions and to couple out the generated WGM laser light. With a pump light in the 1450 nm band, lasing from Er³⁺ions in the WGM resonator occurred in the 1550 nm band. Since the emission from Erbium ions couples into both the cw and ccw modes and the WGM resonators have a rotational symmetry, the outcoupled laser light typically does not have a pre-determined out-coupling direction in the waveguide. With a single fiber tip in the mode field, these initially frequency degenerate modes couple to each other creating split lasing modes. Using another fiber tip as a second scatterer, we investigated the chirality in the WGM microlaser by monitoring the laser field coupled to the waveguide in the cw and ccw directions. For this situation the parameters a and D from above can be conveniently adapted to determine the chirality of lasing modes based on the experimentally accessible quantities. Note that for the lasing modes chirality and directionality are equivalent as they both quantify the intrinsic dynamics of the laser system. We observed that by tuning the relative distance between the scatterers, the chirality of the lasing modes and with it the directional out-coupling to the fiber can be tuned in the same way as shown for the passive resonator (FIG. 15).

As depicted in FIG. 16A, depending on the relative distance between the scatterers one can have a bidirectional laser or a unidirectional laser, which emits only in the cw or the ccw direction. For the bidirectional case, one can also tune the relative strengths of emissions in cw and ccw directions. As expected, the chirality is maximal (±1) for the relative phase angles where strong unidirectional emission is observed (FIG. 16B), and chirality is close to zero for the angles where bidirectional emission is seen. This confirms that by tuning the system to an EP the modes can be made chiral and hence the emission direction of lasing can be controlled: in one of the two EPs, emission is in the cw and in the other EP the emission is in the ccw direction. Thus, by transiting from one EP to another EP the direction of unidirectional emission is completely reversed: an effect demonstrated for the first time here. The fact that the maximum possible chirality values for the lasing system are reached here very robustly can be attributed to the fact that the non-linear interactions in a laser tend to reinforce a modal chirality already predetermined by the resonator geometry.

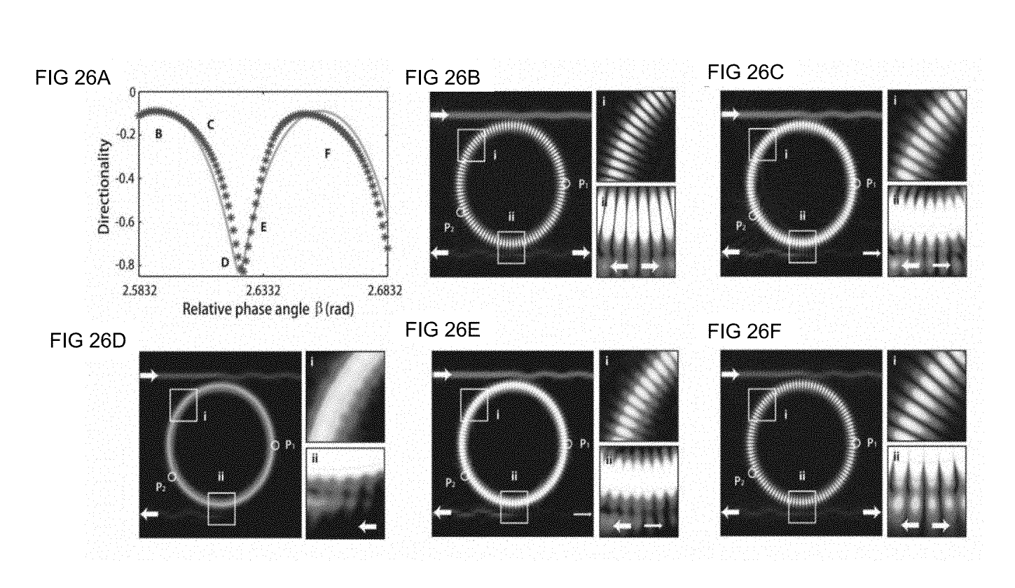

To relate this behavior to the internal field distribution in the cavity, we also performed numerical simulations which revealed that when the intracavity intensity distribution shows a standing-wave pattern with a balanced contribution of cw and ccw propagating components and a clear interference pattern, the emission is bidirectional, in the sense that laser light leaks into the second waveguide in both the cw and ccw directions (FIG. 16C). However, when the distribution does not show such a standard standing-wave pattern but an indiscernible interference pattern, the emission is very directional, such that the intracavity field couples to the waveguide only in the cw or the ccw direction depending on whether the system is at the first or the second EP (FIG. 16, D and E). We also confirmed that the presence or absence of an interference pattern in the field distribution is also linked with a bi- or uni-directional transmission, respectively, observed in FIG. 15 for the passive resonator (FIG. 26).

Summarizing, we have demonstrated chiral modes in whispering-gallery-mode microcavities and microlasers via geometry-induced non-Hermitian mode-couplings. The underlying physical mechanism that enables chirality and directional emission is the strong asymmetric backscattering in the vicinity of an EP which universally occurs in all open physical systems. We believe that our work will lead to new directions of research and to the development of WGM microcavities and microlasers with new functionalities. In addition to controlling the flow of light and laser emission in on-chip micro and nanostructures, our findings have important implications in cavity-QED for the interaction between atoms/molecules and the cavity light. They may also enable high performance sensors to detect nanoscale dielectric, plasmonic and biological particles and aerosols, and be useful for a variety of applications such as the generation of optical beams with a well-defined orbital angular momentum (OAM) (such as OAM microlasers, vortex lasers, etc.) and the topological protection in optical delay lines.

Two-Mode-Approximation (TMA) model and the eigenmode evolution. In this section we briefly review the two-mode approximation (TMA) model and the eigenmode evolution in whispering-gallery-mode (WGM) microcavities with nanoscatterer-induced broken spatial symmetry, as described briefly in the main text. This will help to understand the basic relationship between asymmetric backscattering of counter-propagating waves and the resulting co-propagation, non-orthogonality, and chirality of optical modes. We furthermore derive how the chirality of a lasing mode can be measured by weakly coupling two waveguides to the system. As a complementary schematic of the setup shown in FIG. 13. FIG. 17 presents the details of the involved parameters and the input/output signal directions for clarification.

The TMA model used in our analysis was first phenomenologically introduced for deformed microdisk cavities and was later rigorously derived for the microdisk with two scatterers. The main approach is to model the dynamics in the slowly-varying envelope approximation in the time domain with a Schrödinger-like equation.

$$1 \frac{d}{dt} Ψ = H Ψ \qquad ( S .59 )$$

**Here Ψ, is the complex-valued two-dimensional vector consisting of the field amplitudes of the CCW propagating wave Ψ_{CCW}. and the CW propagating wave Ψ_{CW}. The former corresponds to the [symbol] angular dependence in real space, and the latter to [symbol] ; the positive integer m is the angular mode number. Since the microcavity is an open system, the corresponding effective Hamiltonian,

$$H = ( \begin{matrix}{Ω}_{0} & A \\ B & {Ω}_{0}\end{matrix} ) \qquad ( S .60 )$$

is a 2×2 matrix, which is in general non-Hermitian.

FIG. 17. Schematic of the setup with the definitions of the parameters and signal propagation directions. a_{j, in} (a_{j, out}) denotes the input (output) signal amplitude from the j-th port. K₀, K₁are the cavity decay rate and the cavity-waveguide coupling coefficient, respectively. d₁ (d₂) denotes the effective scattering size factor of the first (second) nanoscatterer (corresponding to the spatial overlap between the scatterer and the optical mode), which is varied by changing the distance between the scatterer and the microresonator. The angle β denotes the relative phase angle between the scatterers.

The real parts of the diagonal elements Ω_{c} are the frequencies and the imaginary parts are the decay rates of the resonant traveling waves. The complex-valued off-diagonal elements A and B are the backscattering coefficients, which describe the scattering from the CW (CCW) to the CCW (CW) travelling wave. In general, in the open system the backscattering is asymmetric, |A|≠|B|, which is allowed because of the non-Hermiticity of the Hamiltonian. The complex eigenvalues of H are,

$${Ω}_{\pm } = {Ω}_{c} \pm \sqrt{AB} \qquad ( S .61 )$$

to which the following complex (not normalized) right eigenvectors are associated,

$${Ψ}_{\pm } = ( \begin{matrix}\sqrt{A} \\ \pm √ B\end{matrix} ) . \qquad ( S .62 )$$

As shown in the text, the asymmetric scattering is closely related with the evolution of the eigenmodes, especially in the vicinity of the exceptional points (EP), where either of the backscattering coefficients A or B is zero and both the eigenvalues (S.61) and the eigenvectors (S.62) coalesce. To verify this interesting feature, we specifically checked the eigenmode evolution in our system both theoretically and experimentally. For the particular case of the WGM microtoroid perturbed by two scatterers the matrix elements of H are determined as follows,

$$\begin{matrix}\begin{matrix} {Ω}_{c} = {Ω}_{0} + {V}_{1} + {U}_{1} + {V}_{2} + {U}_{2} \\ = {ω}_{c} - \frac{{κ}_{0} + 2 {κ}_{1}}{2} 1 + {V}_{1} + {U}_{1} + {V}_{2} + {U}_{2}\end{matrix} & ( S .63 ) \\ A = ( {V}_{1} - {U}_{1} ) + ( {V}_{2} - {U}_{2} ) \text{?} & ( S .64 ) \\ B = ( {V}_{1} - {U}_{1} ) + ( {V}_{2} - {U}_{2} ) \text{?} & ( S .65 ) \\ \text{?} \text{indicates text missing or illegible when filed} & \end{matrix}$$

where ω_{c} denotes the intrinsic cavity resonant frequency, and κ₀ and κ₁ are the cavity decay rate and the cavity-waveguide coupling coefficient. The quantities 2Vⱼ and 2Uⱼ are given by the complex frequency shifts for positive- and negative-parity modes introduced by j-th particle (j==1,2) alone. These quantities can be calculated for the single-particle-microdisk system either fully numerically [using, e.g., the finite-difference time-domain method (FDTD), the boundary element method (BEM)], or analytically using the Green's function approach for point scatterers with Uⱼ=0. Here we used the finite element method (FEM). In our simplified model Uᵢ is set to zero since |U₁|«|V₁|. FIG. 18 presents the evolution of the eigenfrequencies of our system (obtained with FEM simulations) as the phase difference angle β and the effective size factor d are tuned. The EPs can be clearly observed where the eigenfrequencies coalesce, as pointed out in both FIG. 18A and 18B.

FIG. 18. The eigenmode evolution of the non-Hermitian system as a function of the effective size factor d and the relative phase angle β between the scatterers. (A) Real part of the eigenmodes Ω_{±}. (B) Imaginary part of the eigenmodes Ω_{±}. Two exceptional points are clearly seen. EP: Exceptional Point.

Experimental observation of an EP by tuning the size and position of two scatterers. In our experiments with a silica microtoroid WGM resonator, we chose a mode for which there was no observable frequency splitting in the transmission spectra before the introduction of the scatterers. We probed the scatterer-induced chiral dynamics of the WGMs, using two silica nanotips whose relative positions (i.e., relative phase angle β) and sizes within the evanescent field of the WGMs were controlled by nanopositioners (FIG. 13). The size ratio of the scatterers was tuned by enlarging the volume of one of the nanotips within the resonator mode field while keeping the volume of the other nanotip fixed.

FIG. 19. Experimentally obtained mode spectra as the relative phase angle β between the scatterers was varied. β increased continuously from (i) to (viii). Mode coalescence is clearly seen in (v). Modes bifurcated again when β was increased further (vi-viii). The evolution of the eigenmodes of the system was obtained by coupling two waveguides to the system (FIG. 13& 17) and monitoring the transmission spectra (FIG. 19) as the wavelength of a tunable laser was scanned. The two eigenmodes coalesced clearly as the phase difference angle β between the 1^{st} and the 2^{nd} nanoscatterer was varied to the vicinity of the EP but bifurcated again as β was further increased. We also checked the evolution of the eigenfrequencies when the effective size of the 2^{nd} scatterer was varied at different phase difference angles β.

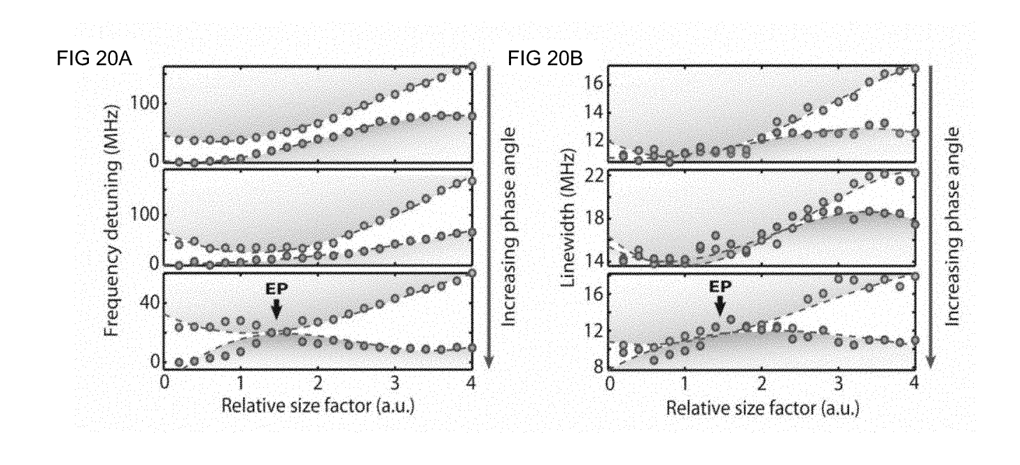

FIG. 20. Experimentally obtained evolution of eigenfrequencies as the relative size of the scatterers was varied at different relative phase angles β. (A) Difference of the real parts of the eigenfrequencies (frequency splitting or frequency detuning). (B) Imaginary parts (linewidths) of the eigenfrequencies.

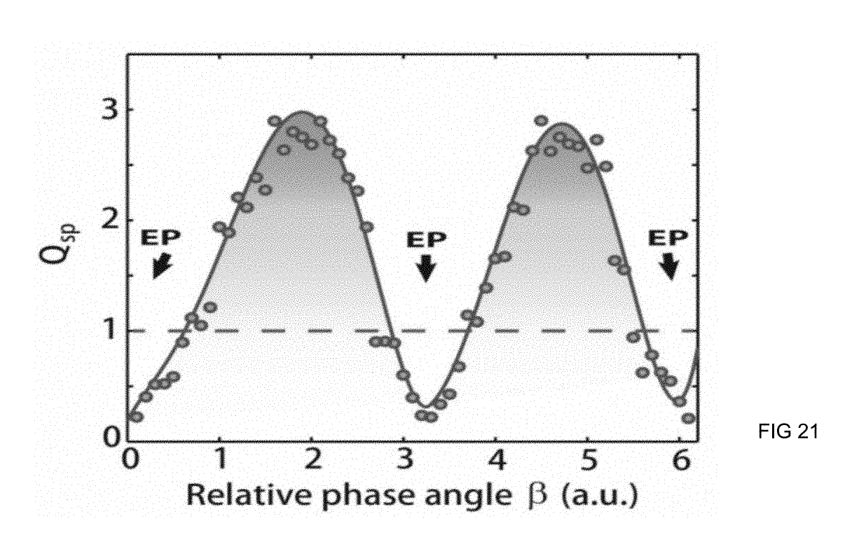

FIG. 21. Experimentally obtained evolution of the splitting quality factor as a function of β for fixed relative size factor. In FIG. 13B of the main text, we presented the evolution of the frequency splitting 2 g, linewidth difference γ_{diff} and the sum yₛᵤₘ of the linewidths of split modes as a function of the relative phase angle β. In FIGS. 20 & 21 we provide more experimental results to further clarify how the relative phase angle β and the relative size factor of the scatterers affect the spectra of the split resonance modes and help to drive the system to the vicinity of an EP. FIG. 20 depicts the evolution of the amount of frequency splitting and the linewidths of the split resonances as a function of the size factor at different values β implying that when the relative size factor is varied, the system can or cannot reach an EP depending on the relative phase angle β between the scatterers: For some values of β, the system experiences avoided crossing. The resolvability of the frequency splitting in a transmission spectrum was previously quantified by the splitting quality factor, which is defined as the ratio of the frequency splitting 2 g to the sum γₛᵤₘ, of the linewidths of the split resonances. Experimental results shown in FIG. 21 clearly show that when the resonances coalesce at an EP, the splitting quality factor reaches its minimum.

Emission and chirality analysis for the lasing cavity. As a consequence of the non-Hermitian character of the Hamiltonian the eigenvectors (S.62) are in general not orthogonal. This happens whenever the backscattering is asymmetric,

$$\vert A \vert \neq \vert B \vert ,$$

as

$${Ψ}_{+}^{*} \cdot {Ψ}_{-} = \vert A \vert - \vert B \vert .$$

The asymmetric backscattering

$$\vert A \vert \neq \vert B \vert$$

also implies that both modes have a dominant component that increases the closer the system is steered to the EP (FIG. 22). This corresponds to a dominant propagation direction in real space. We quantify this imbalance by the chirality

$${α}_{TMA} = \frac{\vert A \vert - \vert B \vert}{\vert A \vert + \vert B \vert} \qquad ( S .66 )$$

In contrast to the original definition of the chirality, this chirality parameter also provides information on the sense of rotation not just on its absolute magnitude. For a balanced contribution, |A|≈|B|, the chirality is close to 0. In the case where the CCW (CW) component dominates, |A|>|B|, (|A|<|B|), the chirality approaches 1 (−1) and both modes become copropagating. It is possible to create a situation of full asymmetry in the backscattering, i.e. a→±1. In this case, either A or B vanishes, while the other component is nonzerol. Solving the Schrödinger Eq. (S.59), we get the eigenfrequencies of the system Eq. (S.61). The corresponding eigenmodes Eq. (S.62) can be further expressed as

Ψ_{±}=Ψ_{CCW}±\sqrt{B/AΨ_{CW}}□ (S.67)

In the experiments, the chirality (S.66) of the eigenmodes of the system can be obtained by coupling waveguides to the system (as shown in FIG. 17) and by inducing lasing (e.g., Raman lasing in silica resonators or lasing from Erbium ions in Erbium doped silica resonators) within the system. Using coupled mode theory and the assumption that there is no backscattering of light from the waveguide into the cavity one can relate the amplitudes in the waveguide to the coefficients A and B via

a_{cw,out}=−\sqrt{κ₁}^{a}Ψ_{CW}=−\sqrt{κ₁}^{a}\sqrt{B} (S.68)

a_{ccw,out}=−\sqrt{κ₁}Ψ_{CCW}=−\sqrt{κ₁}^{a}\sqrt{A} (S.69)

Hence, the chirality of the lasing system can be obtained from the waveguide amplitudes as

$$\begin{matrix} {α}_{testing} = \frac{{\vert \text{?} \vert}^{2} - {\vert \text{?} \vert}^{2}}{{\vert \text{?} \vert}^{2} - {\vert \text{?} \vert}^{2}} & ( S .70 ) \\ \text{?} \text{indicates text missing or illegible when filed} & \end{matrix}$$

where a_{ccwout} can be either a₁ₒᵤₜ or [symbol] and [symbol] can be either or [symbol] or [symbol] . The same formula can also be used in full numerical calculations to extract the chirality of the quasi-bound states of the system for comparison to the result of the two-mode approximation of Eq. (S.66).

FIG. 22. Weights of CW and CCW components in the eigenmodes as the relative phase difference β between the two nanoscatterers is varied, away from EP and in the vicinity of EP, with two different size factors of the 2^{nd} nanoscatterer, according to Eq.(S.67). Evolution of the eigenfrequencies and CW (CCW) weights in the eigenmodes as β is varied for (A) and (B) V₁=1.5−0.1 i, V₂=1.0997−0.065 i, and (C) and (D) V₁=1.5−0.1 i, V₂=1.4999−0.104 i. Note that for the size factor used in (A) and (B) eigenmodes cannot reach the EP whereas for the size factor used in (C) and (D) the eigenmodes can reach the EP and a strong asymmetric distribution of the CW/CCW weights appears in the vicinity of EP. Insets are the zoom-in plots in the vicinity of EP. In (C) and (D), two EPs are clearly seen.

Chirality analysis and comparison between the lasing and the transmission models. In this section we extend the TMA to describe the transmission of light through waveguide-cavity systems as illustrated in FIG. 17, which is also the setup for the results and the analysis shown in FIG. 15 of the main text. We allow for incoming waves from the upper left with amplitude a_{1,in} and from the upper right with amplitude a_{2,in}, such that it is possible to couple into the WGMs in either the CW or the CCW directions. Based on coupled mode theory we add a coupling term to Eq. (S.59) and arrive at

$$\begin{matrix} 1 \frac{d}{dt} Ψ = H Ψ + L \sqrt{{κ}_{1}} ( \text{?} ) & ( S .71 ) \\ \text{?} \text{indicates text missing or illegible when filed} & \end{matrix}$$

with κ₁ denoting the waveguide-resonator coupling coefficient. The losses due to coupling of the cavity to the waveguides are included in the diagonal elements Ω₂ of the Hamiltonian (S.60). Assuming that there is no backscattering of light between the microcavity and the waveguides (which is justified when the distance between cavity and waveguides is sufficiently large) we derive the outgoing amplitudes in the lower waveguide as

$$\begin{matrix}{α}_{TMA} = \frac{\vert A \vert - \vert B \vert}{\vert A \vert + \vert B \vert} & ( S .66 ) \\ {a}_{3 , out} = - \sqrt{{K}_{1}} {}_{}^{*}{Ψ}{}_{CW}^{} & ( S .72 ) \\ {a}_{4 , out} = - \sqrt{{K}_{1}} {}_{}^{*}{Ψ}{}_{CCW}^{} & ( S .73 )\end{matrix}$$

We can choose κ₁ to be real as we are only interested in the absolute values of a_{3,out} and a_{4,out}. For a CW excitation with a₁₋ᵢₙ at a fixed frequency ωₑ we find from Eqs. (S.72)-(S.73)

$$\begin{matrix} \text{?} = \frac{1 {κ}_{1} ( \text{?} - {ω}_{e} )}{{( \text{?} - {ω}_{e} )}^{2} - AB} \text{?} & ( S .74 ) \\ \text{?} = \frac{- 1 {κ}_{1} A}{{( {Ω}_{c} - {ω}_{e} )}^{2} - AB} \text{?} & ( S .75 ) \\ \text{?} \text{indicates text missing or illegible when filed} & \end{matrix}$$

Analogously, for a CCW excitation via a₂₋ᵢₙ we find

$$\begin{matrix} \text{?} = \frac{- 1 {κ}_{1} B}{{( {Ω}_{c} - {ω}_{e} )}^{2} - AB} \text{?} & ( S .76 ) \\ \text{?} = \frac{- 1 {κ}_{1} ( {Ω}_{c} - {ω}_{e} )}{{( {Ω}_{c} - {ω}_{e} )}^{2} - AB} \text{?} & ( S .77 ) \\ \text{?} \text{indicates text missing or illegible when filed} & \end{matrix}$$

The asymmetric backscattering expresses itself here by the fact that the numerator of a_{4,out} in Eq. (S.75) is proportional to A, whereas the numerator of a_{3,out} in Eq.(S.76) is proportional to B. Assuming that the input amplitudes a₁₋ᵢₙ and a₂₋ᵢₙ are the same, we find the chirality as defined by Eq. (S.66) in terms of the transmission amplitudes to be

$$\begin{matrix} {α}_{transmission} = \frac{\vert \text{?} \vert - \vert \text{?} \vert}{\vert \text{?} \vert + \vert \text{?} \vert} & ( S .78 ) \\ \text{?} \text{indicates text missing or illegible when filed} & \end{matrix}$$

where a_{4,out} (a_{3,out}) has been obtained by injecting light at port 1 (2). The crucial difference between the formulas for the chirality as measured in the lasing system [Eq. (S.70)] and the formula for the chirality |a|² measured in a transmission experiment [Eq. (S.78)] is that in the former the intensities, |a|² of the outgoing waveguide modes are used, whereas in the latter only the modulus of the amplitudes, |a|, appear.

In order to compare the two different chirality formulas, Eqs. (S.70) and (S.78), we have performed numerical calculations using a finite element method where we have solved the inhomogeneous Helmholtz equation. The calculations were restricted to the transverse magnetic (TM) polarization in two dimensions. The geometry of the system is shown in FIG. 17. The parameters for the waveguides and scatterers have been chosen such that the scatterers perturb the eigenvalues of the system much stronger than the waveguides coupled to the resonator. Therefore, the chirality is determined primarily through the scatterers, similar to the experiment. One of the scatterers had a fixed position, situated at an angle of π/2 with respect to the waveguides. The second scatterer was situated on the opposite side of the disk and its position was given by the angle β between the scatterers. The effective size factor, d₂, of the second scatterer (which is the spatial overlap between the scatterer and the optical mode) was varied by changing the distance between the scatterer and the resonator. In the calculations the angle β was varied between 2.91 and 3.06, and the size factor d₂ was varied between 0.01 and 0.04. The waveguides, as well as the microresonator had an effective refractive index of n=1.444. The system was excited by injecting light into the waveguides at any of the ports 1-4 with frequency ωₑachieved by placing a line source f (y) at the corresponding side of the system (marked by a black dashed line in FIG. 17), which excites only the fundamental mode f(y,ωₑ) [symbol] of the waveguide. Both, the spatial profile f(y,ωₑ) of the fundamental mode, as well as the ropagation coefficient βₓ were found through matching conditions at the dielectric waveguide interface. The computational domain was truncated by a reflectionless perfectly matched layer, which absorbs all scattered outgoing waves. The incoming and outgoing amplitudes a_{1-4(in,out)} of the waveguide modes were extracted by projecting the solution of the inhomogeneous Helmholtz equation onto the individual (fundamental) waveguide modes.

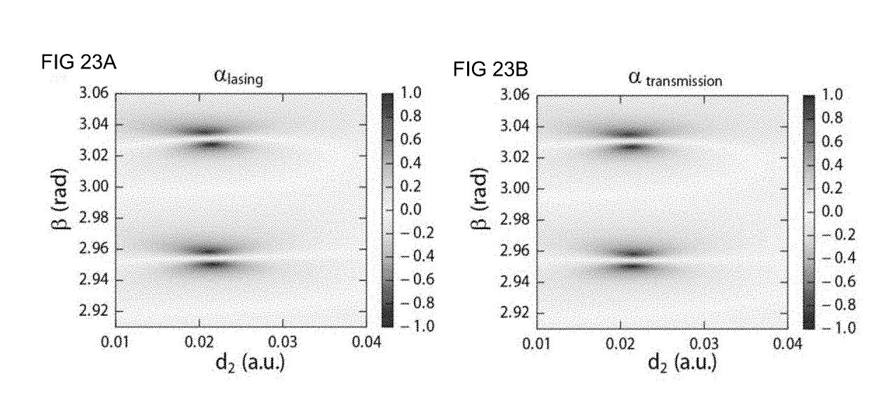

In FIG. 23 we compare the chirality as determined from the eigenvalue calculations for the lasing cavity with the chirality as determined from the transmission calculations. The chirality is obtained under variation of the two positional parameters (d₂, β) of the second scatterer. We chose to vary two parameters in order to be able to exactly reach the exceptional points where the chirality features an absolute maximum, i.e. α=±1. In the parameter range shown in FIG. 23 two pairs of EPs are depicted where each pair features two EPs of opposite chirality. The pattern of EP pairs is roughly repetitive when extending the scanned interval of angle β as long as the scatterer does not come close to one of the attached waveguides. In the calculations we observe an excellent agreement between the two chirality definitions such that we can indeed assume that both methods yield a good estimate for the internal chirality of the whispering gallery modes induced by the presence of the two scatterers.

FIG. 23. Comparison of the chirality obtained (A) through a full numerical eigenvalue calculation by Eq. (S.70) and (B) through a full numerical transmission calculation by Eq. (S.78). The dependence of the chirality is plotted with respect to the position of the second scatterer given by both the angle between the scatterers, β, as well as by the effective size factor, d₂. Both formulas yield very similar values for the chirality validating Eqs. (S.70) and (S.78).

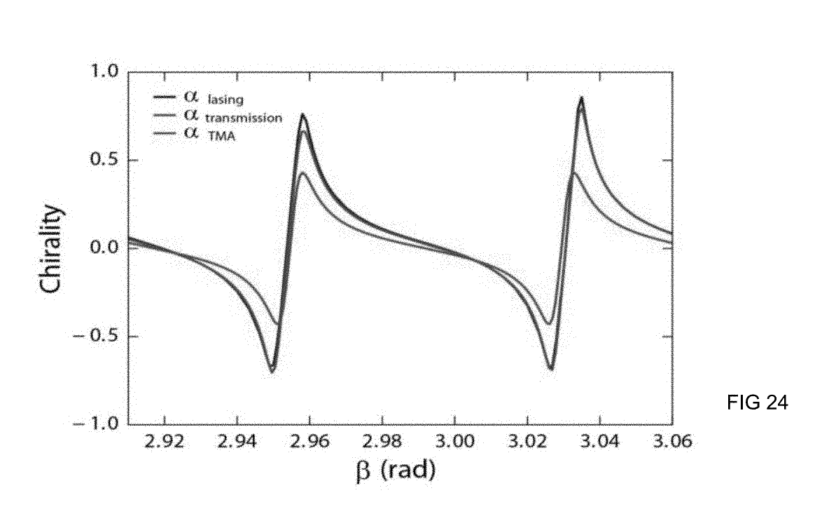

In a next step we explicitly compared the full numerical results to the results from the TMA model. For this, we calculated the parameters A, β, and ω_{c} through separate eigenvalue calculations for each of the scatterers, where no waveguides were attached to the system. The value for the coupling coefficient κ₁ has been determined from transmission calculations from port 1 to port 3 with no scatterers present. In FIG. 24 the chirality definitions of Eqs. (S.66), (S.70) and (S.78) are compared to each other for the case that the distance of the 2^{nd} nanotip is fixed at the same distance as the 1^{st} nanotip, i.e. d₂=0.02. Similar to FIG. 23 we again observe an excellent agreement between the numerical calculations. For the TMA model we find that it correctly predicts the angles at which the chirality becomes minimal/maximal, but the exact values differ. The reason for this is that the TMA model does not include other scattering processes as, for example, from the resonator to the waveguide.

FIG. 24. Comparison of the chirality definitions for α_{TMA}, α_{lasing} and αₜᵣₐₙₛₘᵢₛₛᵢₒₙ. In the calculations the second scatterer has an effective size factor d₂=0.02 and the angle β is varied.

FIG. 25. Asymmetric backscattering intensities |B_{CW/CCW}|² from a CW to a CCW wave [left panel: (A) and (C)] and from a CCW to a CW mode [right panel: (B) and (D)]. The results are obtained from a full numerical transmission calculation using a finite element method [upper panel: (A) and (B)], as well as from the TMA model [lower panel: (C) and (D)]. Both models yield the same frequencies at which the backscattering intensities peak, but the overall intensities differ from each other since additional scattering processes as from the waveguide to the resonator are not included in the TMA. In each panel the backscattering intensity is shown as functions of the injected frequency detuning ωₑ−ωₐ and the angular position β of the second nanotip. Dashed lines mark the local minima of backscattering intensities, corresponding to the chirality maxima and minima. The asymmetric backscattering is shown by the shifted intensity patterns with respect to the angle β.

The asymmetric backscattering which results in the intriguing chirality behavior in FIG. 24 can also be observed by looking at the normalized backscattering intensity |B_{CCW}|²=|a_{CCW,out}|²/|a_{CW,in}|² from the CW to CCW traveling mode and the similarly defined |B_{CW}|². From Eq. (S.70) it follows that an exceptional point (with an absolute chirality maximum) is reached when either of the backscattering intensities |B_{CW/CCW}|² is zero. Hence, a chirality maximum (minimum) can be found by minimizing the backscattering intensity |R_{CCW}|² (|R_{CW}|²). This strategy has also been used in the experiment and the corresponding data is shown in FIG. 14 of the main text. The EPs corresponding to opposite chiralities occur at slightly different angles β, which manifests itself by shifting the two backscattering intensity pattern |B_{CW/CCW}|² with respect to the angle β as shown in FIG. 25. Here, the angles β at which the backscattering |B_{CW/CCW}|² becomes minimal are indicated by dashed lines. In addition, both the results for the TMA model and the numerical transmission calculations are plotted. The frequencies at which the backscattering intensities |B_{CW/CCW}|² peak match very well between the two models; however, the predicted overall intensities differ due to the differences in the models.

Directionality analysis for the biased input case in the transmission model. As discussed in the main text, the intrinsic chirality is different from the directionality when light is injected into the resonator in a preferred direction such as in the CW or the CCW direction (i.e., we referred to this as the biased input). Our experiments described in the main text revealed that varying the relative distance (relative spatial phase) between the scatterers affects the amount of light coupled out of the resonator into the forward direction (i.e., in the direction of the input) and into the backward direction (i.e., in the opposite direction of the input); however, the amount of light coupled out of the resonator into the forward direction always remains higher than that in the backward direction.

FIG. 26. Directionality with a biased input (CW) as a function of the relative phase difference between two scatterers (A). Summary of the results obtained in the numerical simulation and the fitting curve using the theoretical model. (B-F), Results of finite element simulations at different relative phase angles β but fixed size factor revealing the intracavity field patterns and output direction in the waveguides. β values are: (B) 2.590 rad; (C) 2.617 rad; (D) 2.625 rad; (E) 2.631 rad; and (F) 2.653 rad. P₁ and P₂ denote the locations of the scatterers.

FIG. 26 depicts the results of finite element simulations with COMSOL validating our experimental observations presented in FIGS. 14&15 in the main text. It is seen that directionality is always negative taking values between its minimum and maximum values by changing the relative phase angle. Decreasing directionality implies the presence of scattering into the direction opposite to the direction of the injected light. Backward scattering, however, remains always weaker than forward scattering. Simulations reveal that when the intracavity field forms a standing-wave pattern with well-defined nodal lines, light couples out from the resonator in both the cw and ccw directions (FIG. 26B); however, when nodal lines are washed out and the field profile deviates from the standing-wave pattern light couples out from the resonator in the direction of the input (FIG. 26D). A relation between the visibility of the nodal lines (and the standing-wave pattern) and the ratio of the light coupled into cw and ccw directions is clearly seen (FIG. 26).

As is evident from the foregoing description, certain aspects of the present technology as disclosed are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

What is claimed is:

1. A method for chaos transfer between multiple signals comprising:
transmitting multiple detuned signals in an optical micro cavity resonator with optomechanically induced oscillation where at least one signal is stronger than and detuned with respect to at least one other signal; and
increasing the power of the at least one signal whereby as the power is increased the at least one signal and the at least one other signal follow the same route, from periodic oscillations to quasi-periodic and finally to chaotic oscillations.

2. The method for chaos transfer as recited in claim 1, where the at least one signal is an optical field pump exciting mechanical oscillations in the resonator and the at least one other signal is an optical field probe and where chaos transfer from the pump to the probe is mediated by the mechanical motion of the resonator.

3. The method for chaos transfer as recited in claim 2, where the at least one signal is a pump laser and the at least one other signal is a probe laser

4. The method for chaos transfer as recited in claim 3, where optomechanically induced chaos modulate the at least one other signal at a frequency of the mechanical oscillation.

5. The method for chaos transfer as recited in claim 4, where transmitting multiple signals in an optical micro cavity resonator includes coupling the at least one signal and the at least one other signal into and out of the micro cavity resonator with one or more of a waveguide, an optical fiber and free-space, and separating the at least one signal from the at least one other signal with a wavelength division multiplexer.

6. The method for chaos transfer as recited in claim 5, comprising:
detecting the pump and probe signals for a maximal Lyapunov exponent and controlling increasing power of the at least one signal responsive to the maximal Lyapunov exponent detected.

7. The method for chaos transfer as recited in claim 6, comprising:
detecting the at least one other signal with a photo detector

8. A system demonstrating chaos transfer between multiple signals comprising:
a first signal generator configured to transmit a first signal through an optical micro cavity resonator;
a second signal generator configured to transmit a second signal through the optical micro cavity resonator where the second signal generator is configured to transmit said second signal that is weaker than the first signal and second signal is detuned with respect to the first signal; and
a photo detector and spectral analyzer configured to detect the transmitted light and calculating a maximal Lyapunov exponent of the first and second signals.

9. The system demonstrating chaos transfer as recited in claim 8, where the first signal generator is an optical field pump and the second signal generator is an optical field probe.

10. The system demonstrating chaos transfer as recited in claim 9, where the optical field pump is a pump laser and the optical field probe is a probe laser.

11. The system demonstrating chaos transfer as recited in claim 10, where the optical micro cavity resonator is configured to generate mechanical oscillations responsive to the first signal and modulate said second signal with the mechanical oscillations.

12. The system demonstrating chaos transfer as recited in claim 11, comprising:
one or more of a waveguide, optical fiber and free space configured and positioned with respect to the optical micro cavity resonator to couple the first signal and the second signal into and out of the micro cavity resonator ; and
a wavelength division multiplexer configured to separate the first signal from the second signal.

13. A method for chaos transfer between multiple signals comprising:
transfering the optomechanically-induced chaos on an optical field in a microcavity resonator to weaker optical signal in the same microcavity resonator and said weaker optical signal is detuned each other in their optical frequencies and/or wavelengths by selectively tuning the signals such that their frequency is detuned from an optical resonance of the resonator by the frequency of the mechanical frequency which is excited by the optical field.

14. The method as recited in claim 13, comprising:
controlling the mechanical oscillations with the optical field and hence optomechanically-inducing Kerr-like nonlinearity, chaos and backaction noise, such that stochastic resonance is observed, and such that the signal to noise ratio of the weaker probe field having a power below detection threshold;
selectively increasing the power to the optical field suth that the weaker signal is detectable such that as the pump power increases the signal-to-noise ratio of the weaker signal increases up to its maximum value and then starts to decrease as the pump power continues to increase.

15. A method comprising:
steering a waveguide-coupled microresonator or a microlaser to its exceptional point (EP);
controlling the chirality of the light circulating in the microresonator thereby controlling the emission direction of the microlaser; and
tuning the microresonator from an EP to another EP, such that the emission direction of the laser is be tuned from a unidirectional emission in the clockwise direction to a unidirectional emission in the counter-clockwise direction.

16. The method as recited in claim 15, comprising:
steering the microresonator away from the EPs, thereby obtaining bidirectional.
